(19) United States
(12) Patent Application Publication
(10) Pub. No.: US 2021/0135282 A1
(43) Pub. Date: May 6, 2021

(54) Solid Electrolyte Composite Particle, Powder, And Method For Producing Composite Solid Electrolyte Molded Body

(71) Applicant: Seiko Epson Corporation, Tokyo (JP)

(72) Inventors: Masahiro FURUSAWA, Chino (JP); Tomofumi YOKOYAMA, Matsumoto (JP); Tsutomu TERAOKA, Matsumoto (JP); Hitoshi YAMAMOTO, Chino (JP); Naoyuki TOYODA, Suwa (JP)

(21) Appl. No.: 17/088,922

(22) Filed: Nov. 4, 2020

(30) Foreign Application Priority Data
Nov. 5, 2019 (JP) 2019-201090

(51) Int. Cl. H01M 10/0562; H01M 10/0525

(52) U.S. Cl. CPC H01M 10/0562; H01M 2300/0094; H01M 2300/0071; H01M 10/0525

(57) ABSTRACT

A solid electrolyte composite particle according to the present disclosure includes: a mother particle formed of a first solid electrolyte containing at least lithium; and a coating layer formed of a material containing an oxide different from the first solid electrolyte, a lithium compound, and an oxo acid compound, and coating at least a part of a surface of the mother particle. The oxo acid compound may contain at least one of a nitrate ion and a sulfate ion as an oxo anion.

The present application is based on, and claims priority from JP Application Serial Number 2019-201090, filed Nov. 5, 2019, the disclosure of which is hereby incorporated by reference herein in its entirety.

### BACKGROUND

### 1. Technical Field

The present disclosure relates to a solid electrolyte composite particle, a powder, and a method for producing a composite solid electrolyte molded body.

### 2. Related Art

In recent years, rapid charge and discharge characteristics are required in a lithium ion secondary battery. There is a problem that charge and discharge capacities generated during rapid charging and discharging decreases significantly. Therefore, experiments have been performed to reduce a so-called internal resistance such as an electric resistance of an active material layer which is a constituent member of a battery and an ionic conduction resistance of a separator layer. In particular, attention has been focused on a technique for reducing an internal resistance of a positive electrode active material layer that occupies a large proportion of an internal resistance of a battery. In order to reduce the internal resistance of the positive electrode active material layer, examples that have been put into practical use include an example in which an active material mixture is thinned and molded to reduce a resistance value, an example in which a carbon nanotube is adopted in a conductive auxiliary, and an example in which a part of oxygen that constitutes the positive electrode active material is substituted by nitrogen and an electronic conductivity of the positive electrode active material is improved.

However, in a charge transfer process that occurs when lithium ions move in and out between the positive electrode active material and a solid electrolyte, when an interface is not sufficiently formed, lithium ions are deficient in the vicinity of the interface, and a charge transfer reaction is not performed. Therefore, even when the internal resistance is reduced by an electrical design unit, there is limitation in forming an all-solid battery that can be used in practice.

In recent years, attention has been focused on an experiment to reduce a charge transfer resistance and to prevent ion deficiency during charge and discharge at a high rate by providing a material that acts in an electrical state of an interface on which a charge transfer occurs between the positive electrode active material and the solid electrolyte.

For example, JP-A-2018-147726 discloses a positive electrode material having a structure in which a ferroelectric is provided on a surface of a positive electrode active material. Accordingly, a concentration of lithium ions is high, a so-called hot spot is created, and a charge transfer frequency is increased, so that a charge transfer resistance during charge and discharge at a high rate is reduced.

JP-A-2019-3786 discloses a positive electrode active material having a structure in which specific active material particles are coated with a specific coating layer. Accordingly, the same effect as described above is obtained.

However, in the configuration disclosed in JP-A-2018-147726, since the ferroelectric lacks an ionic conductivity, there are problems that the internal resistance is increased and a capacity is reduced on the contrary during charge and discharge commonly used under a low load.

In the configuration disclosed in JP-A-2019-3786, although an ionic conductor is likely to become porous and an effect of improving charge and discharge capacity retention rates under a low load is obtained, a technique for drastically improving charge and discharge performances under a high load is not achieved.

### SUMMARY

The present disclosure has been made to solve the problems described above and can be implemented as the following application examples.

A solid electrolyte composite particle according to an application example of the present disclosure contains: a mother particle formed of a first solid electrolyte containing at least lithium; and a coating layer formed of a material containing an oxide different from the first solid electrolyte, a lithium compound, and an oxo acid compound, and coating at least a part of a surface of the mother particle.

In the solid electrolyte composite particle according to another application example of the present disclosure, the first solid electrolyte is an oxide solid electrolyte.

In the solid electrolyte composite particle according to another application example of the present disclosure, the first solid electrolyte is a garnet type oxide solid electrolyte.

In the solid electrolyte composite particle according to another application example of the present disclosure, the oxo acid compound includes at least one of a nitrate ion and a sulfate ion as an oxo anion.

In the solid electrolyte composite particle according to another application example of the present disclosure, a crystal phase of the oxide is a pyrochlore type crystal.

In the solid electrolyte composite particle according to another application example of the present disclosure, an average particle diameter of the mother particles is 1.0 μm or more and 30 μm or less.

In the solid electrolyte composite particle according to another application example of the present disclosure, an average thickness of the coating layers is 0.002 μm or more and 3.0 μm or less.

In the solid electrolyte composite particle according to another application example of the present disclosure, the coating layer coats 10% or more of an area of the surface of the mother particle.

A powder according to an application example of the present disclosure contains a plurality of the solid electrolyte composite particles according to the present disclosure.

A method for producing a composite solid electrolyte molded body according to an application example of the present disclosure includes: a molding step of forming a molded body by molding a composition containing a plurality of the solid electrolyte composite particles according to the present disclosure; and a heat treatment step of converting a constituent material of the coating layer into a second solid electrolyte which is an oxide by subjecting the molded body to a heat treatment, and forming the composite solid electrolyte molded body containing the first solid electrolyte and the second solid electrolyte.

In the method for producing a composite solid electrolyte molded body according to another application example of the present disclosure, a heating temperature for the molded body in the heat treatment step is 700° C. or higher and 1000° C. or lower.

In the method for producing a composite solid electrolyte molded body according to another application example of the present disclosure, the first solid electrolyte and the second solid electrolyte are substantially the same.

### BRIEF DESCRIPTION OF THE DRAWINGS

FIG. 1 is a schematic cross-sectional view showing a solid electrolyte composite particle according to the present disclosure.

FIG. 2 is a schematic perspective view showing a configuration of a lithium ion secondary battery according to a first embodiment.

FIG. 3 is a schematic perspective view showing a configuration of a lithium ion secondary battery according to a second embodiment.

FIG. 4 is a schematic cross-sectional view showing a structure of the lithium ion secondary battery according to the second embodiment.

FIG. 5 is a schematic perspective view showing a configuration of a lithium ion secondary battery according to a third embodiment.

FIG. 6 is a schematic cross-sectional view showing a structure of the lithium ion secondary battery according to the third embodiment.

FIG. 7 is a schematic perspective view showing a configuration of a lithium ion secondary battery according to a fourth embodiment.

FIG. 8 is a schematic cross-sectional view showing a structure of the lithium ion secondary battery according to the fourth embodiment.

FIG. 9 is a flowchart showing a method for producing the lithium ion secondary battery according to the first embodiment.

FIG. 10 is a schematic view showing the method for producing the lithium ion secondary battery according to the first embodiment.

FIG. 11 is a schematic view showing the method for producing the lithium ion secondary battery according to the first embodiment.

FIG. 12 is a schematic cross-sectional view showing another method for forming a solid electrolyte layer.

FIG. 13 is a flowchart showing a method for producing the lithium ion secondary battery according to the second embodiment.

FIG. 14 is a schematic view showing the method for producing the lithium ion secondary battery according to the second embodiment.

FIG. 15 is a schematic view showing the method for producing the lithium ion secondary battery according to the second embodiment.

FIG. 16 is a flowchart showing a method for producing the lithium ion secondary battery according to the third embodiment.

FIG. 17 is a schematic view showing the method for producing the lithium ion secondary battery according to the third embodiment.

FIG. 18 is a schematic view showing the method for producing the lithium ion secondary battery according to the third embodiment.

FIG. 19 is a flowchart showing a method for producing the lithium ion secondary battery according to the fourth embodiment.

FIG. 20 is a schematic view showing the method for producing the lithium ion secondary battery according to the fourth embodiment.

### DESCRIPTION OF EXEMPLARY EMBODIMENTS

Hereinafter, preferred embodiments of the present disclosure will be described in detail.

### 1. Solid Electrolyte Composite Particle

First, a solid electrolyte composite particle according to the present disclosure will be described.

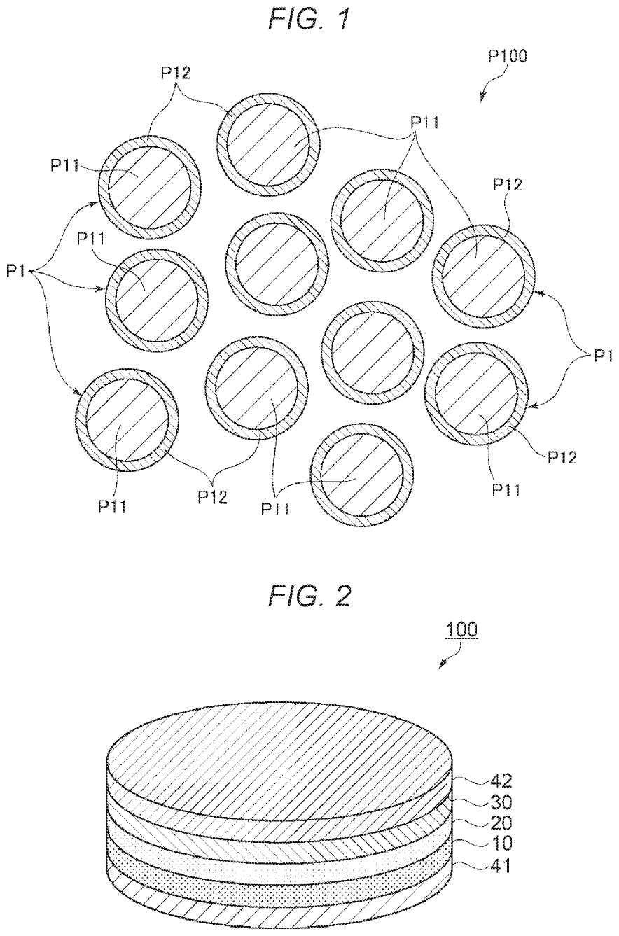

FIG. 1 is a schematic cross-sectional view showing a solid electrolyte composite particle according to the present disclosure. Although the entire surface of a mother particle P11 is coated with a coating layer P12 for convenience in FIG. 1, the present disclosure is not limited thereto.

A solid electrolyte composite particle P1 according to the present disclosure is used to form a composite solid electrolyte molded body which will be described in detail later. In particular, the solid electrolyte composite particle P1 is generally used as a powder P100 which is an aggregate of a plurality of the solid electrolyte composite particles P1. That is, the powder P100 according to the present disclosure contains a plurality of the solid electrolyte composite particles P1. As shown in FIG. 1, the solid electrolyte composite particle P1 includes a mother particle P11 and a coating layer P12 coating at least a part of a surface of the mother particle P11. The mother particle P11 is formed of a first solid electrolyte containing at least lithium. The coating layer P12 is formed of a material containing an oxide different from the first solid electrolyte, a lithium compound, and an oxo acid compound.

Accordingly, it is possible to provide a solid electrolyte composite particle that can be suitably used to produce a composite solid electrolyte molded body which is formed of a solid electrolyte having a low grain boundary resistance of a solid electrolyte, an excellent ionic conductivity, and a high denseness. More specifically, since the coating layer P12 contains the oxo acid compound, a melting point of the oxide contained in the coating layer P12 can be reduced. Accordingly, in a calcination treatment which is a heat treatment performed at a relatively low temperature for a relatively short period, a constituent material of the coating layer P12 can be converted into a second solid electrolyte that is an oxide while promoting crystal growth. At the same time, adhesion to the first solid electrolyte that constitutes the mother particle P11, adhesion between second solid electrolytes corresponding to coating layers P12 of respective solid electrolyte composite particles P1, and the like can be improved. As a result, the formed composite solid electrolyte molded body has a high denseness, a low grain boundary resistance of the solid electrolytes, and an excellent ionic conductivity. Since a reaction can be performed in which lithium ions are incorporated into the oxide contained in the coating layer P12 during the reaction, the second solid electrolyte that is a lithium-containing composite oxide can be formed at a low temperature. Therefore, a decrease in an ionic conductivity due to volatilization of lithium ions can be prevented, and the composite solid electrolyte molded body can be suitably applied to producing an all-solid battery having an excellent battery capacity under a high load.

On the other hand, when conditions described above are not satisfied, a satisfying result is not obtained.

For example, unlike the solid electrolyte composite particle according to the present disclosure, for a particle formed only of the first solid electrolyte without the coating layer, when a composition containing a plurality of the particles is calcined, a gap is likely to be formed between the particles, and a solid electrolyte having a sufficiently high denseness cannot be obtained. As a result, the obtained solid electrolyte has a high grain boundary resistance and a poor ionic conductivity. In particular, such a problem occurs more remarkably when calcination of the composition is performed at a relatively low temperature, which will be described later.

For a particle formed only of the constituent material of the coating layer without the mother particle, when a composition containing a plurality of the particles is calcined, it is difficult to sufficiently increase the denseness.

Even for a particle having a structure in which coating layer is provided on the surface of the mother particle, when the coating layer does not contain the oxo acid compound, an effect of lowering a melting point of the oxide is not obtained. When a composition containing a plurality of the particles is calcined, a gap is likely to be formed between the particles, and a solid electrolyte having a sufficiently high denseness cannot be obtained. As a result, the obtained solid electrolyte has a high grain boundary resistance and a poor ionic conductivity. In particular, such a problem occurs more remarkably when calcination of the composition is performed at a relatively low temperature, which will be described later.

Even for the particle having a structure in which the coating layer is provided on the surface of the mother particle, when the coating layer does not contain the oxide, a solid electrolyte that is a lithium-containing composite oxide cannot be formed.

Even for the particle having a structure in which the coating layer is provided on the surface of the mother particle, when the coating layer does not contain the lithium compound, a solid electrolyte that is a lithium-containing composite oxide cannot be formed.

Hereinafter, the solid electrolyte composite particle P1 containing the mother particle P11 and the coating layer P12 coating the mother particle P11 will be described in detail.

### 1.1 Mother Particle

The mother particle P11 constituting the solid electrolyte composite particle P1 is formed of a first solid electrolyte. When the solid electrolyte composite particle P1 has a core-shell structure, the mother particle P11 corresponds to a core in the core-shell structure.

The first solid electrolyte may have any composition as long as the composition functions as a solid electrolyte. The first solid electrolyte may be an oxysulfide, an oxynitride, and the like, and is preferably an oxide.

Accordingly, generation of a toxic gas is prevented, and air stability is improved.

The first solid electrolyte may have any crystal phase. Examples of the first solid electrolyte include a garnet type oxide solid electrolyte, a perovskite type oxide solid electrolyte, and a NASICON type oxide solid electrolyte.

When the first solid electrolyte is a garnet type oxide solid electrolyte, effects such as improvement of the ionic conductivity of the solid electrolyte after sintering, improvement of mechanical strength, and improvement of battery safety by improving stability can be obtained.

When the first solid electrolyte is a perovskite type oxide solid electrolyte, sintering can be performed at a lower temperature.

When the first solid electrolyte is a NASICON type oxide solid electrolyte, air stability is improved.

Examples of the garnet type oxide solid electrolyte include Li₇La₃Zr₂O₇ and materials in which Li, La, and Zr sites are partially substituted with various metals, such as Li_{6.75}La₃Zr_{1.75}Ta_{0.25}O₇, Li_{6.3}La₃Zr_{1.3}Sb_{0.5}Ta_{0.2}O₇, and Li_{6.7}Al_{0.1}La₃Zr₂O₇.

Examples of the perovskite type oxide solid electrolyte include La_{0.57}Li_{0.29}TiO₃.

Examples of the NASICON type oxide solid electrolyte include Li₁₊ₓAlₓTi₂₋ₓ(PO₄)₃.

An average particle diameter of the mother particles P11 is not particularly limited, and is preferably 1.0 μm or more and 30 μm or less, more preferably 2.0 μm or more and 25 μm or less, and even more preferably 3.0 μm or more and 20 μm or less.

Accordingly, the solid electrolyte composite particle P1 can be easily adjusted to have a suitable size, flowability and handling easiness of the solid electrolyte composite particle P1 can be improved. The solid electrolyte composite particle P1 is adjusted to have a suitable size, so that thickness of the coating layer P12 and a ratio of an average thickness of the coating layers P12 to an average particle diameter of the mother particles P11 are easily adjusted to values within a suitable range. As a result, the composite solid electrolyte molded body produced using the solid electrolyte composite particle P1 can have a lower grain boundary resistance, a higher ionic conductivity, and a higher denseness. This is also advantageous from viewpoints of improving productivity and reducing production cost of the solid electrolyte composite particle P1.

In the present specification, the average particle diameter refers to an average particle diameter on a volume basis, and can be calculated by, for example, adding a sample into methanol and measuring, by a Coulter counter particle size distribution analyzer (TA-II type manufactured by Coulter Electronics Inc.), a dispersion liquid dispersed for 3 minutes by an ultrasonic disperser using an aperture of 50 μm.

In the drawings, although the mother particle P11 has a true spherical shape, a shape of the mother particle P11 is not limited thereto.

The powder P100 may contain the solid electrolyte composite particles P1 in which conditions of the mother particles P11 are different from each other. For example, the powder P100 may contain the solid electrolyte composite particles P1 in which the mother particles P11 have different particle diameters, the solid electrolyte composite particles P1 in which the mother particles P11 have different compositions, and the like as the solid electrolyte composite particles P1 in which the conditions of the mother particles P11 are different from each other.

### 1.2 Coating Layer

The coating layer P12 coating the mother particle P11 is formed of a material containing an oxide different from the first solid electrolyte, a lithium compound, and an oxo acid compound. When the solid electrolyte composite particle P1 has a core-shell structure, the coating layer P12 corresponds to a shell in the core-shell structure.

### 1.2.1 Oxide

The oxide constituting the coating layer P12 is different from the first solid electrolyte constituting the mother particle P11. More specifically, for example, when the first solid electrolyte constituting the mother particle P11 is an oxide solid electrolyte, the oxide constituting the coating layer P12 is different from the oxide constituting the mother particle P11 in a composition or a crystal phase at a normal temperature and a normal pressure.

Hereinafter, the oxide constituting the coating layer P12 is also referred to as a “precursor oxide”.

In the present specification, the normal temperature refers to 25° C. and the normal pressure refers to 1 atm. In the present specification, “different” for the crystal phase is a broad concept including that types of crystal phases are not the same, and that at least one lattice constant is different even when the types are the same.

The crystal phase of the precursor oxide may be any crystal phase, and is preferably a pyrochlore type crystal.

Accordingly, even when a heat treatment for the solid electrolyte composite particle P1 is performed at a lower temperature for a shorter period, a composite solid electrolyte molded body having a particularly excellent ionic conductivity can be suitably obtained. In particular, in a case in which the crystal phase of the first solid electrolyte is a cubic garnet type crystal, when the crystal phase of the precursor oxide is a pyrochlore type crystal, adhesion between the first solid electrolyte constituting the mother particle P11 and the second solid electrolyte formed by the constituent material of the coating layer P12 can be further improved. As a result, a composite solid electrolyte molded body produced using the solid electrolyte composite particle P1 can have a lower grain boundary resistance, a higher ionic conductivity, and a higher denseness.

In addition to the pyrochlore type crystal described above, examples of the crystal phase of the precursor oxide may include a cubic crystal having a perovskite structure, a rock salt structure, a diamond structure, a fluorite structure, or a spinel structure, a ramsdellite type orthorhombic crystal, and a corundum type trigonal crystal.

The composition of the precursor oxide is not particularly limited, and the precursor oxide is preferably a composite oxide containing La, Zr, and M. M is at least one element selected from the group consisting of Nb, Ta, and Sb.

Accordingly, even when a heat treatment for the solid electrolyte composite particle P1 is performed at a lower temperature for a shorter period, a composite solid electrolyte molded body having a particularly excellent ionic conductivity can be suitably obtained. For example, in an all-solid battery, adhesion to a positive electrode active material or a negative electrode active material of a formed solid electrolyte can be further improved, materials can be combined to have a better adhesion interface, and characteristics and reliability of the all-solid battery can be further improved.

M is at least one element selected from the group consisting of Nb, Ta, and Sb, and preferably contains two or more elements selected from the group consisting of Nb, Ta, and Sb.

Accordingly, the effects described above are more remarkably exhibited.

When the precursor oxide is a composite oxide containing La, Zr, and M, it is preferable that a ratio of substance amounts of La, Zr, and M contained in the precursor oxide is 3:2-x:x, and a relationship of 0<x<2.0 is satisfied.

Accordingly, the effects described above are more remarkably exhibited.

A crystal particle diameter of the precursor oxide is not particularly limited, and is preferably 10 nm or more and 200 nm or less, more preferably 15 nm or more and 180 nm or less, and even more preferably 20 nm or more and 160 nm or less.

Accordingly, a melting temperature of the precursor oxide and a calcination temperature of the solid electrolyte composite particle P1 can be further lowered by a so-called Gibbs-Thomson effect which is a melting point lowering phenomenon caused by an increase in surface energy. This is advantageous in improving adhesion between the solid electrolyte formed using the solid electrolyte composite particle P1 and a different material and in reducing defect density.

The precursor oxide is preferably formed of a substantially single crystal phase.

Accordingly, since the number of crystal phase transition that occurs when the composite solid electrolyte molded body is produced using the solid electrolyte composite particle P1, that is, when a high temperature crystal phase is generated, is substantially one, generation of impurity crystals due to element segregation or element thermal decomposition accompanying with the crystal phase transition is prevented, and various properties of the produced composite solid electrolyte molded body are further improved.

In a case in which only one exothermic peak in a range of 300° C. or higher and 1,000° C. or lower is observed when the solid electrolyte composite particle P1 is measured by TG-DTA at a temperature rising rate of 10° C./min, it can be determined that the solid electrolyte composite particle P1 is formed of a “substantially single crystal phase”.

A content of the precursor oxide in the coating layer P12 is not particularly limited, and is preferably 35 mass % or more and 85 mass % or less, more preferably 45 mass % or more and 85 mass % or less, and even more preferably 55 mass % or more and 85 mass % or less.

Accordingly, even when a heat treatment for the solid electrolyte composite particle P1 is performed at a lower temperature for a shorter period, a composite solid electrolyte molded body having a particularly excellent ionic conductivity can be suitably obtained.

The solid electrolyte composite particle P1 may contain a plurality of types of precursor oxides. When the solid electrolyte composite particle P1 contains a plurality of types of precursor oxides, a sum of contents of the precursor oxides in the solid electrolyte composite particle P1 is used as a content value.

### 1.2.2 Lithium Compound

The coating layer P12 contains a lithium compound.

Accordingly, the second solid electrolyte formed by the coating layer P12 can be formed of a lithium-containing composite oxide, and characteristics such as an ionic conductivity can be improved.

Examples of the lithium compound contained in the coating layer P12 include inorganic salts such as LiH, LiF, LiCl, LiBr, LiI, LiClO, LiClO₄, LiNO₃, LiNO₂, Li₃N, LiN₃, LiNH₂, Li₂SO₄, Li₂S, LiOH, and Li₂CO₃, carboxylates such as lithium formate, lithium acetate, lithium propionate, lithium 2-ethylhexanoate, and lithium stearate, hydroxy acid salts such as lithium lactate, lithium malate, and lithium citrate, dicarboxylate salts such as lithium oxalate, lithium malonate, and lithium maleate, alkoxides such as methoxylithium, ethoxylithium, and isopropoxylithium, alkylated lithium such as methyllithium and n-butyllithium, sulfate esters such as n-butyl lithium sulfate, n-hexyl lithium sulfate, and lithium dodecyl sulfate, diketone complexes such as 2,4-pentanedionatolithium, and derivatives thereof such as hydrates and halogen substitutes. One type or a combination of two or more types selected from the examples of the lithium compound may be used.

Among these, the lithium compound is preferably one or two types selected from the group consisting of Li₂CO₃ and LiNO₃.

Accordingly, the effects described above are more remarkably exhibited.

A content of the lithium compound in the coating layer P12 is not particularly limited, and is preferably 10 mass % or more and 20 mass % or less, more preferably 12 mass % or more and 18 mass % or less, and even more preferably 15 mass % or more and 17 mass % or less.

Accordingly, even when a heat treatment for the solid electrolyte composite particle P1 is performed at a lower temperature for a shorter period, a composite solid electrolyte molded body having a particularly excellent ionic conductivity can be suitably obtained.

When the content of the precursor oxide in the coating layer P12 is defined as XP (mass %) and the content of the lithium compound in the coating layer P12 is defined as XL (mass %), it is preferable to satisfy a relationship of 0.13≤XL/XP≤0.58, more preferable to satisfy a relationship of 0.15≤XL/XP≤0.4, and even more preferable to satisfy a relationship of 0.18≤XL/XP≤0.3.

Accordingly, even when a heat treatment for the solid electrolyte composite particle P1 is performed at a lower temperature for a shorter period, a composite solid electrolyte molded body having a particularly excellent ionic conductivity can be suitably obtained.

The coating layer P12 may contain a plurality of types of lithium compounds. When the coating layer P12 contains a plurality of types of lithium compounds, a sum of contents of the lithium compounds in the coating layer P12 is used as a content value.

### 1.2.3 Oxo Acid Compound

The coating layer P12 contains an oxo acid compound that contains no metal element other than lithium.

When the coating layer 12 contains such an oxo acid compound, the melting point of the precursor oxide can be suitably lowered, and crystal growth of the lithium-containing composite oxide can be promoted. When a heat treatment is performed in a relatively low temperature for a relatively short period, a composite solid electrolyte molded body formed of a solid electrolyte having a low grain boundary resistance of a solid electrolyte, an excellent ionic conductivity, and a high denseness can be suitably formed.

The oxo acid compound is a compound containing an oxo anion.

Examples of the oxo anion constituting the oxo acid compound include a halogen oxoate ion, a borate ion, a carbonate ion, an orthocarbonate ion, a carboxylate ion, a silicate ion, a nitrite ion, a nitrate ion, a phosphite ion, a phosphate ion, an arsenate ion, a sulfite ion, a sulfate ion, a sulfonate ion, and a sulfinate ion. Examples of the halogen oxoate ion include a hypochlorite ion, a chlorite ion, a chlorate ion, a perchlorate ion, a hypobromite ion, a bromite ion, a bromate ion, a perbromate ion, a hypoiodite ion, an iodite ion, an iodate ion, and a periodate ion.

In particular, the oxo acid compound preferably contains, as the oxo anion, at least one of a nitrate ion and a sulfate ion, and more preferably a nitrate ion.

Accordingly, the melting point of the precursor oxide can be more suitably reduced, and the crystal growth of the lithium-containing composite oxide can be more effectively promoted. As a result, even when a heat treatment for the solid electrolyte composite particle P1 is performed at a lower temperature for a shorter time, a composite solid electrolyte molded body having a particularly excellent ionic conductivity can be suitably obtained.

A cation constituting the oxo acid compound is not particularly limited. Examples of the cation include a hydrogen ion, an ammonium ion, a lithium ion, a lanthanum ion, a zirconium ion, a niobium ion, a tantalum ion, and an antimony ion. One type or a combination of two or more types selected from the examples of the cation may be used. The cation is preferably an ion of a constituent metal element of the second solid electrolyte formed by the coating layer P12.

Accordingly, it is possible to more effectively prevent undesirable impurities from remaining in the formed second solid electrolyte.

When the oxo acid compound is a compound containing a lithium ion and an oxo anion, the compound can be referred to as an oxo acid compound and a lithium compound.

A content of the oxo acid compound in the coating layer P12 is not particularly limited, and is preferably 0.1 mass % or more and 20 mass % or less, more preferably 1.5 mass % or more and 15 mass % or less, and even more preferably 2.0 mass % or more and 10 mass % or less.

Accordingly, the oxo acid compound can be more reliably prevented from unintentionally remaining in the second solid electrolyte formed by the coating layer P12, and even when a heat treatment for the solid electrolyte composite particle P1 is performed at a lower temperature for a shorter time, a composite solid electrolyte molded body having a particularly excellent ionic conductivity can be suitably obtained.

When the content of the precursor oxide in the coating layer P12 is XP (mass %) and the content of the oxo acid compound in the coating layer P12 is XO (mass %), it is preferable to satisfy a relationship 0.013≤XO/XP≤0.58, and more preferable to satisfy a relationship of 0.021≤XO/XP≤0.34, and even more preferable to satisfy a relationship of 0.02≤XO/XP≤0.19.

Accordingly, the oxo acid compound can be more reliably prevented from unintentionally remaining in the second solid electrolyte formed by the coating layer P12, and even when a heat treatment for the solid electrolyte composite particle P1 is performed at a lower temperature for a shorter time, a composite solid electrolyte molded body having a particularly excellent ionic conductivity can be suitably obtained.

When a content of the lithium compound in the coating layer P12 is XL (mass %) and the content of the oxo acid compound in the coating layer P12 is XO (mass %), it is preferable to satisfy a relationship of 0.05≤XO/XL≤2, more preferable to satisfy a relationship of 0.08≤XO/XL≤1.25, and even more preferable to satisfy a relationship of 0.11≤XO/XL≤0.67.

Accordingly, the oxo acid compound can be more reliably prevented from unintentionally remaining in the second solid electrolyte formed by the coating layer P12, and even when a heat treatment for the solid electrolyte composite particle P1 is performed at a lower temperature for a shorter time, a composite solid electrolyte molded body having a particularly excellent ionic conductivity can be suitably obtained.

The coating layer P12 may contain a plurality of types of oxo acid compounds. When the coating layer P12 contains a plurality of types of oxo acid compounds, a sum of contents of the oxo acid compounds in the coating layer P12 is used as a content value.

### 1.2.4 Other Components

As described above, the coating layer P12 contains a precursor oxide, a lithium compound, and an oxo acid compound, and may further contain other components. Among the components constituting the coating layer P12, components other than the precursor oxide, the lithium compound, and the oxo acid compound are referred to as “other components”.

Examples of the other components contained in the coating layer P12 include a first solid electrolyte, a second solid electrolyte, and a solvent component used in a production process of the solid electrolyte composite particle P1.

A content of the other components in the coating layer P12 is not particularly limited, and is preferably 10 mass % or less, more preferably 5.0 mass % or less, and even more preferably 0.5 mass % or less.

The coating layer P12 may contain a plurality of types of components as the other components. In this case, a sum of contents of the other components in the coating layer P12 is used as a content value.

When M is at least one element selected from the group consisting of Nb, Ta, and Sb, the coating layer P12 preferably contains Li, La, Zr, and M. In particular, it is preferable that a ratio of substance amounts of Li, La, Zr, and M contained in the coating layer P12 is 7-x:3:2-x:x, and a relationship of 0<x<2.0 is satisfied.

Accordingly, the ionic conductivity of the second solid electrolyte formed by the coating layer P12 can be further improved, and the ionic conductivity of the entire composite solid electrolyte molded body produced using the solid electrolyte composite particle P1 can also be further improved.

Here, x satisfies the relationship of 0<x<2.0, and preferably satisfies a relationship of 0.01<x<1.75, more preferably satisfies a relationship of 0.1<x<1.25, and even more preferably satisfies a relationship of 0.2<x<1.0.

Accordingly, the effects described above are more remarkably exhibited.

An average thickness of the coating layers P12 is preferably 0.002 μm or more and 3.0 μm or less, more preferably 0.03 μm or more and 2.0 μm or less, and even more preferably 0.05 μm or more and 1.5 μm or less.

Accordingly, the size of the solid electrolyte composite particle P1 and a ratio of the average thickness of the coating layers P12 to the average particle diameter of the mother particles P11 are easily adjusted within suitable ranges. As a result, for example, flowability and handling easiness of the solid electrolyte composite particle P1 can be improved, and the composite solid electrolyte molded body produced using the solid electrolyte composite particle P1 can have a lower grain boundary resistance, a higher ionic conductivity, and a higher denseness. This is also advantageous from viewpoints of improving productivity and reducing production cost of the solid electrolyte composite particle P1. Charge and discharge performances under a high load of a lithium ion secondary battery to which the solid electrolyte composite particle P1 is applied can be further improved.

In the present specification, the average thickness of the coating layers P12 refers to a thickness of the coating layer P12 calculated based on a ratio of the mother particles P11 and the coating layers P12 that are contained in the whole powder P100 when it is assumed that the mother particle P11 each have a true spherical shape having a diameter same as the average particle diameter of the mother particles P11 and the coating layers P12 each having a uniform thickness are formed on entire outer surfaces of the mother particles P11.

When the average particle diameter of the mother particles P11 is defined as D (μm) and the average thickness of the coating layers P12 is defined as T (μm), it is preferable to satisfy a relationship of 0.0004≤T/D≤1.0, more preferable to satisfy a relationship of 0.0010≤T/D≤0.30, and even more preferable to satisfy a relationship of 0.0020≤T/D≤0.15.

Accordingly, the size of the solid electrolyte composite particle P1 and the average thickness of the coating layers P12 are easily adjusted within suitable ranges. As a result, for example, flowability and handling easiness of the solid electrolyte composite particle P1 can be improved, and the composite solid electrolyte molded body produced using the solid electrolyte composite particle P1 can have a lower grain boundary resistance, a higher ionic conductivity, and a higher denseness. This is also advantageous from viewpoints of improving productivity and reducing production cost of the solid electrolyte composite particle P1. Charge and discharge performances under a high load of a lithium ion secondary battery to which the solid electrolyte composite particle P1 is applied can be further improved.

The coating layer P12 coats at least a part of a surface of the mother particle P11. A coating ratio of the coating layer P12 to an outer surface of the mother particle P11, that is, a proportion of an area of a portion coated with the coating layer P12 with respect to the entire area of the outer surface of the mother particle P11 is not particularly limited. The proportion is preferably 10% or more, more preferably 30% or more, and even more preferably 50% or more. An upper limit of the coating ratio may be 100% or less.

Accordingly, a composite solid electrolyte molded body produced using the solid electrolyte composite particle P1 can have a lower grain boundary resistance, a higher ionic conductivity, and a higher denseness. Charge and discharge performances under a high load of a lithium ion secondary battery to which the solid electrolyte composite particle P1 is applied can be further improved.

A proportion of a mass of the coating layer P12 to a total mass of the solid electrolyte composite particle P1 is preferably 2 mass % or more and 55 mass % or less, more preferably 10 mass % or more and 45 mass % or less, and even more preferably 25 mass % or more and 35 mass % or less.

Accordingly, the composite solid electrolyte molded body produced using the solid electrolyte composite particle P1 can have a lower grain boundary resistance, a higher ionic conductivity, and a higher denseness. Charge and discharge performances under a high load of a lithium ion secondary battery to which the solid electrolyte composite particle P1 is applied can be further improved.

The coating layer P12 constituting the solid electrolyte composite particle P1 may have portions having different conditions. For example, the coating layer P12 has a first portion that coats a part of a surface of a mother particle P11 and a second portion that coats a surface of the mother particle P11 that is not coated with the first portion. The first portion and the second portion may have different compositions. The coating layer P12 constituting the solid electrolyte composite particle P1 may be a stacked body including a plurality of layers having different compositions. The coating layer P12 coating the mother particle P11 may have a plurality of regions having different thicknesses.

The powder P100 may contain the solid electrolyte composite particles P1 in which the coating layers P12 have different conditions from each other. For example, the powder P100 may contain the solid electrolyte composite particles P1 in which the coating layers P12 have different thicknesses and the solid electrolyte composite particles P1 in which the coating layers P12 have different compositions as the solid electrolyte composite particles P1 in which the coating layers P12 have different conditions.

### 1.3 Other Configurations

The solid electrolyte composite particle P1 contains the mother particle P11 and the coating layer P12 as described above, and may further contain other configurations. Examples of such a configuration include at least one intermediate layer provided between the mother particle P11 and the coating layer P12, and another coating layer that is provided at a portion of the outer surface of the mother particle P11 not coated with the coating layer P12 and is formed of a material different from that of the coating layer P12.

However, a proportion of configurations other than the mother particle P11 and the coating layer P12 in the solid electrolyte composite particle P1 is preferably 3.0 mass % or less, more preferably 1.0 mass % or less, and even more preferably 0.3 mass % or less.

The powder P100 may contain a plurality of the solid electrolyte composite particles P1 described above, and may further contain other configurations in addition to the solid electrolyte composite particles P1.

Examples of such a configuration include particles formed of a material same as that of the mother particle P11 and not coated with the coating layer P12, and particles formed of a material same as that of the coating layer P12 and not attached to the mother particle P11. Examples of the other configurations include particles formed of a material same as that of the mother particle P11 and coated with a material other than that of the coating layer P12, particles whose mother particle is formed of a material other than the material of the mother particle P11 described above and whose surface of the mother particle P11 is coated with a material same as the material of the coating layer P12, and particles of a solid electrolyte formed of a material different from the material of the mother particle P11.

However, a proportion of the configurations other than the solid electrolyte composite particles P1 in the powder P100 is preferably 20 mass % or less, more preferably 10 mass % or less, and even more preferably 5 mass % or less.

A proportion of the solid electrolyte composite particles P1 in the powder P100 is preferably 80 mass % or more and 100 mass % or less, more preferably 90 mass % or more and 100 mass % or less, and even more preferably 95 mass % or more and 100 mass % or less.

A boundary between the mother particle P11 and the coating layer P12 may be clear as shown in FIG. 1. Alternatively, the boundary may not necessarily be clear. For example, a part of constituent components of one of the mother particle P11 and the coating layer P12 may be shifted to the other one.

In the powder 100, half or more of the solid electrolyte composite particles P1 among the solid electrolyte composite particles P1 constituting the powder P100 preferably satisfy the conditions described above. Among preferable conditions of the solid electrolyte composite particles P1 described above, numerical value conditions preferably satisfy an average value for each solid electrolyte composite particle P1.

### 2. Method for Producing Solid Electrolyte Composite Particle

Next, a method for producing a solid electrolyte composite particle will be described.

The solid electrolyte composite particle can be suitably produced by using a method including a mixed liquid preparing step, a drying step, and an oxide forming step.

The mixed liquid preparing step is a step of preparing a mixed liquid in which a lithium compound and a metal compound containing a metal element other than lithium are dissolved and particles of the first solid electrolyte are dispersed.

The drying step is a step of removing liquid components from the mixed liquid to obtain a solid mixture.

The oxide forming step is a step of subjecting the solid mixture to a heat treatment and forming an oxide by reacting the solid mixture with the metal compound, so as to form the particles of the first solid electrolyte as the mother particle P11, and to form the coating layer P12 on the surface of the mother particle P11. The coating layer P12 is formed of a material containing an oxide different from the first solid electrolyte, a lithium compound, and an oxo acid compound.

Accordingly, the solid electrolyte composite particle that can be suitably used for producing a composite solid electrolyte molded body formed of a solid electrolyte having a low grain boundary resistance of the solid electrolyte, an excellent ionic conductivity, and a high denseness can be efficiently produced.

Hereinafter, each step will be described.

### 2.1 Mixed Liquid Preparing Step

In the mixed liquid preparing step, a lithium compound and a metal compound containing a metal element other than lithium are dissolved and particles of the first solid electrolyte are dispersed to prepare a mixed liquid.

More specifically, for example, in a case in which the second solid electrolyte is a garnet type solid electrolyte represented by the following formula (1), in the mixed liquid preparing step, when M is at least one element selected from the group consisting of Nb, Ta, and Sb, a metal compound containing the metal element M, a lithium compound, a lanthanum compound, and a zirconium compound are dissolved and particles of the first solid electrolyte are dispersed to prepare the mixed liquid.

Li₇₋ₓLa₃(Zr₂₋ₓMₓ)O₁₂ (1)

(In the formula (1), M represents one or more metal elements selected from Ta, Sb, and Nb, and a relationship of 0.1≤x≤1.0 is satisfied.)

In the following description, the second solid electrolyte is a garnet type solid electrolyte represented by formula (1), and a case of preparing the mixed liquid will be mainly described.

An order of mixing components constituting the mixed liquid is not particularly limited. For example, a lithium raw material solution in which the lithium compound is dissolved, a lanthanum raw material solution in which the lanthanum compound is dissolved, a zirconium raw material solution in which the zirconium compound is dissolved, a metal raw material solution in which the metal compound containing the metal element M is dissolved, and the particles of the first solid electrolyte can be mixed to obtain the mixed liquid.

In such a case, for example, the lithium raw material solution, the lanthanum raw material solution, the zirconium raw material solution, and the metal raw material solution may be mixed in advance before being mixed with the particles of the first solid electrolyte. In other words, for example, the particles of the first solid electrolyte may be mixed with a mixed solution of the lithium raw material solution, the lanthanum raw material solution, the zirconium raw material solution, and the metal raw material solution.

In the case described above, the particles of the first solid electrolyte may be used for mixing with the above solution in a state of a dispersion liquid in which the particles of the first solid electrolyte are dispersed in a dispersion medium.

As described above, when a plurality of types of liquids are used in the mixed liquid preparing step, a solvent and a dispersion medium that serve as constituent components of the solution and the dispersion liquid may have a common composition or may have different compositions.

In the mixed liquid preparing step, it is preferable to use the lithium compound such that a content of lithium in the mixed liquid is 1.05 times or more and 1.2 times or less of a stoichiometric composition in the above formula (1).

In the mixed liquid preparing step, it is preferable to use the lanthanum compound such that a content of lanthanum in the mixed liquid is equal to the stoichiometric composition in the above formula (1).

In the mixed liquid preparing step, it is preferable to use the zirconium compound such that a content of zirconium in the mixed liquid is equal to the stoichiometric composition in the above formula (1).

In the mixed liquid preparing step, it is preferable to use the metal compound containing the metal element M such that a content of M in the mixed liquid is equal to the stoichiometric composition in the above formula (1).

Examples of the lithium compound include a lithium metal salt and a lithium alkoxide. One type or a combination of two or more types among the examples of the lithium compound may be used. Examples of the lithium metal salt include lithium chloride, lithium nitrate, lithium sulfate, lithium acetate, lithium hydroxide, lithium carbonate, and (2,4-pentanedionato) lithium. Examples of the lithium alkoxide include lithium methoxide, lithium ethoxide, lithium propoxide, lithium isopropoxide, lithium butoxide, lithium isobutoxide, lithium secondary butoxide, lithium tertiary butoxide, and dipivaloylmethanatolithium. Among these, the lithium compound is preferably one or two or more selected from the group consisting of lithium nitrate, lithium sulfate, and (2,4-pentanedionato) lithium. A hydrate thereof may be used as a lithium source.

Examples of the lanthanum compound which is a metal compound as a lanthanum source include a lanthanum metal salt, a lanthanum alkoxide, and a lanthanum hydroxide. One type or a combination of two or more types among the examples of the lanthanum compound may be used. Examples of the lanthanum metal salt include lanthanum chloride, lanthanum nitrate, lanthanum sulfate, lanthanum acetate, and tris(2,4-pentanedionato) lanthanum. Examples of the lanthanum alkoxide include lanthanum trimethoxide, lanthanum triethoxide, lanthanum tripropoxide, lanthanum triisopropoxide, lanthanum tributoxide, lanthanum triisobutoxide, lanthanum tri-secondary butoxide, lanthanum tertiary butoxide, and dipivaloylmethanatolanthanum. Among these, the lanthanum compound is preferably at least one selected from the group consisting of lanthanum nitrate, tris(2,4-pentanedionato) lanthanum, and lanthanum hydroxide. A hydrate thereof may be used as the lanthanum source.

Examples of the zirconium compound which is a metal compound as a zirconium source include a zirconium metal salt and a zirconium alkoxide. One type or a combination of two or more types among the examples of the zirconium compound may be used. Examples of the zirconium metal salt include zirconium chloride, zirconium oxychloride, zirconium oxynitrate, zirconium oxysulfate, zirconium oxyacetate, and zirconium acetate. Examples of the zirconium alkoxide include zirconium tetramethoxide, zirconium tetraethoxide, zirconium tetrapropoxide, zirconium tetraisobutoxide, zirconium tetra-secondary butoxide, zirconium tetra-tertiary butoxide, and dipivaloylmethanatozirconium. Among these, the zirconium compound is preferably zirconium tetrabutoxide. A hydrate thereof may be used as the zirconium source.

Examples of a tantalum compound which is a metal compound as a tantalum source, as the metal element M, include a tantalum metal salt and a tantalum alkoxide. One type or a combination of two or more types among the examples of the tantalum compound may be used. Examples of the tantalum metal salt include tantalum chloride and tantalum bromide. Examples of the tantalum alkoxide include tantalum pentamethoxide, tantalum pentaethoxide, tantalum pentaisopropoxide, tantalum penta-normal-propoxide, tantalum pentaisobutoxide, tantalum penta-normal-butoxide, tantalum penta-secondary butoxide, and tantalum penta-tertiary butoxide. Among these, the tantalum compound is preferably tantalum pentaethoxide. A hydrate thereof may be used as the tantalum source.

Examples of an antimony compound which is a metal compound as an antimony source, as the metal element M, include an antimony metal salt and an antimony alkoxide. One type or a combination of two or more types among the examples of the antimony compound may be used. Examples of the antimony metal salt include antimony bromide, antimony chloride, and antimony fluoride. Examples of the antimony alkoxide include antimony trimethoxide, antimony triethoxide, antimony triisopropoxide, antimony tri-normal-propoxide, antimony triisobutoxide, and antimony tri-normal-butoxide. Among these, the antimony compound is preferably antimony triisobutoxide. A hydrate thereof may be used as the antimony source.

Examples of a niobium compound which is a metal compound as a niobium source, as the metal element M, include a niobium metal salt, a niobium alkoxide, and niobium acetylacetone. One type or a combination of two or more types among the examples of the niobium compound may be used. Examples of the niobium metal salt include niobium chloride, niobium oxychloride, and niobium oxalate. Examples of the niobium alkoxide include niobium ethoxides such as niobium pentaethoxide, niobium propoxide, niobium isopropoxide, and niobium secondary butoxide. Among these, the niobium compound is preferably niobium pentaethoxide. A hydrate thereof may be used as the niobium source.

As the particles of the first solid electrolyte used in preparation of the mixed liquid, particles satisfying conditions same as those of the mother particles P11 described above can be suitably used, for example.

As the particles of the first solid electrolyte, for example, particles having conditions different from those of the mother particles P11, particularly particles having diameter conditions different from that of the mother particles P11 may be used in consideration of crushing, aggregation, and the like in a production process of the solid electrolyte composite particle P1.

The solvent and the dispersion medium are not particularly limited, and various organic solvents or the like may be used. More specifically, examples of the solvent and the dispersion medium include alcohols, glycols, ketones, esters, ethers, organic acids, aromatics, and amides. A mixed solvent containing one type or a combination of two or more types selected from the examples of the solvent and the dispersion medium may be used. Examples of the alcohols include methyl alcohol, ethyl alcohol, n-propyl alcohol, isopropyl alcohol, n-butyl alcohol, allyl alcohol, and 2-n-butoxyethanol. Examples of the glycols include ethylene glycol, propylene glycol, butylene glycol, hexylene glycol, pentanediol, hexanediol, heptanediol, and dipropylene glycol. Examples of the ketones include dimethyl ketone, methyl ethyl ketone, methyl propyl ketone, and methyl isobutyl ketone. Examples of the esters include methyl formate, ethyl formate, methyl acetate, and methyl acetoacetate. Examples of the ethers include diethylene glycol monomethyl ether, diethylene glycol monoethyl ether, diethylene glycol dimethyl ether, ethylene glycol monomethyl ether, ethylene glycol monoethyl ether, and dipropylene glycol monomethyl ether. Examples of the organic acids include formic acid, acetic acid, 2-ethyl-butyric acid, and propionic acid. Examples of the aromatics include toluene, o-xylene, and p-xylene. Examples of the amides include formamide, N,N-dimethylformamide, N,N-diethylformamide, dimethylacetamide, and N-methylpyrrolidone. Among these, the solvent and the dispersion medium are at least one of 2-n-butoxyethanol and propionic acid.

The mixed liquid prepared in the present step preferably contains an oxo anion.

Accordingly, an oxo acid compound can be suitably contained in the finally obtained solid electrolyte composite particle P1, and the effects described above can be more suitably exhibited. As compared with a case in which the oxo anion is contained, the productivity of the solid electrolyte composite particle P1 can be improved in steps subsequent to the present step. An unintended variation in a composition of the finally obtained solid electrolyte composite particle P1 can be more effectively prevented.

In the present step, when the mixed liquid is prepared as a mixed liquid containing an oxo anion, metal salts containing oxo anions are preferably used as various metal compounds as a raw material for forming the coating layer P12 described above. Alternatively, an oxo acid compound containing an oxo anion may be further used as a component different from the various metal compounds in the preparation of the mixed liquid.

Examples of the oxo anion include a halogen oxoate ion, a borate ion, a carbonate ion, an orthocarbonate ion, a carboxylate ion, a silicate ion, a nitrite ion, a nitrate ion, a phosphite ion, a phosphate ion, an arsenate ion, a sulfite ion, a sulfate ion, a sulfonate ion, and a sulfinate ion. Examples of the halogen oxoate ion include a hypochlorite ion, a chlorite ion, a chlorate ion, a perchlorate ion, a hypobromite ion, a bromite ion, a bromate ion, a perbromate ion, a hypoiodite ion, an iodite ion, an iodate ion, and a periodate ion.

The oxo acid compound may be added at timing later than the mixed liquid preparing step.

### 2.2 Drying Step

The drying step is a step of obtaining a solid mixture by removing liquid components from the mixed liquid obtained in the mixed liquid preparing step. Here, the solid mixture also includes a mixture in which a part of the mixture is in a gel form.

The solid mixture obtained in the present step may be a solid mixture in which at least a part of the liquid components contained in the mixed liquid, that is, the solvent or the dispersion medium described above is removed, or may be a solid mixture in which all of the liquid components is removed.

The present step can be performed by, for example, subjecting the mixed liquid obtained in the mixed liquid preparing step to a treatment using a centrifuge and removing a supernatant.

A precipitate separated from the supernatant by centrifugation may be mixed with the mixed liquid, and then a series of treatments including ultrasonic dispersion and centrifugation may be performed for a predetermined number of times. Accordingly, the thickness of the coating layer P12 can be suitably adjusted.

The present step may be performed, for example, by performing a heat treatment.

In this case, conditions of the heat treatment depend on boiling points of the solvent and the dispersion medium, vapor pressure, and the like. A heating temperature in the heat treatment is preferably 50° C. or higher and 250° C. or lower, more preferably 60° C. or higher and 230° C. or lower, and even more preferably 80° C. or higher and 200° C. or lower.

A heating time in the heat treatment is preferably minutes or longer and 180 minutes or shorter, more preferably 20 minutes or longer and 120 minutes or shorter, and even more preferably 30 minutes or longer and 60 minutes or shorter.

The heat treatment may be performed in any atmosphere, may be performed in an oxidizing atmosphere such as air or an oxygen gas atmosphere, or may be performed in a non-oxidizing atmosphere of an inert gas such as a nitrogen gas, a helium gas, and an argon gas. The heat treatment may be performed under reduced pressure or vacuum, or may be performed under pressurization.

In the heat treatment, the atmosphere may be maintained under substantially the same conditions, or may be changed under different conditions.

In the present step, the treatments described above may be combined.

### 2.3 Oxide Forming Step

In the oxide forming step, the solid mixture obtained in the drying step is subjected to a heat treatment, and the metal compound is reacted with the solid mixture to form an oxide, so as to form the particles of the first solid electrolyte as the mother particle P11, and to form the coating layer P12 on the surface of the mother particle P11. The coating layer 12 is formed of a material containing an oxide different from the first solid electrolyte, a lithium compound, and an oxo acid compound.

The oxide formed in the present step is different from the first solid electrolyte constituting the mother particle P11.

The heat treatment in the present step may be performed under a constant condition, or may be performed by combining different conditions.

The condition of the heat treatment in the present step depends on a composition of the formed precursor oxide. A heating temperature in the present step is preferably 400° C. or higher and 600° C. or lower, more preferably 430° C. or higher and 570° C. or lower, and even more preferably 450° C. or higher and 550° C. or lower.

A heating time in the present step is preferably minutes or longer and 180 minutes or shorter, more preferably 10 minutes or longer and 120 minutes or shorter, and even more preferably 15 minutes or longer and 60 minutes or shorter.

The heat treatment in the present step may be performed in any atmosphere, may be performed in an oxidizing atmosphere such as air or an oxygen gas atmosphere, or may be performed in a non-oxidizing atmosphere of an inert gas such as a nitrogen gas, a helium gas, and an argon gas. The present step may be performed under reduced pressure or vacuum, or may be performed under pressurization. In particular, the present step is preferably performed in an oxidizing atmosphere.

### 3. Method for Producing Composite Solid Electrolyte Molded Body

Next, a method for producing a composite solid electrolyte molded body according to the present disclosure will be described.

A method for producing a composite solid electrolyte molded body according to the present disclosure includes a molding step of obtaining a molded body by molding a composition containing a plurality of the solid electrolyte composite particles P1 according to the present disclosure, and a heat treatment step of converting a constituent material of the coating layer into a second solid electrolyte that is an oxide by subjecting the molded body to a heat treatment, and forming the composite solid electrolyte molded body containing the first solid electrolyte and the second solid electrolyte.

Accordingly, it is possible to provide a method for producing a composite solid electrolyte molded body formed of a solid electrolyte having a low grain boundary resistance of a solid electrolyte, an excellent ionic conductivity, and a high denseness.

### 3.1 Molding Step

In the molding step, the molded body is obtained by molding the composition containing a plurality of the solid electrolyte composite particles P1 according to the present disclosure.

In the present step, the powder P100 described above can be used as the composition. When the powder P100 is used, two or more types of powders P100 having different conditions may be mixed and used. For example, the different conditions include different conditions of the contained solid electrolyte composite particles P1, more specifically, different conditions such as an average particle diameter of the solid electrolyte composite particles P1, a size or a composition of the mother particle P11 constituting the solid electrolyte composite particle P1, and a thickness or a composition of the coating layer P12. In addition to the powder P100, other components may be used as the composition.

Examples of such other components include a dispersion medium for dispersing the solid electrolyte composite particles P1, a positive electrode active material, a negative electrode active material, solid electrolyte particles other than the solid electrolyte composite particles P1, particles formed of a material as the constituent material of the coating layer P12 of the solid electrolyte composite particles P1, and a binder.

In particular, when a positive electrode mixture which will be described in detail later is produced as the composite solid electrolyte molded body, the composition preferably contains a positive electrode active material as the other components. When a negative electrode mixture which will be described in detail later is produced as the composite solid electrolyte molded body, the composition preferably contains a negative electrode active material as the other components.

For example, the composition can be formed into a paste form or the like by using a dispersion medium, and flowability and handling easiness of the composition are improved.

A content of the other components in the composition is preferably 20 mass % or less, more preferably 10 mass % or less, and even more preferably 5 mass % or less.

The other components may be added to the molded body after the molded body is obtained by using the composition in order to improve stability of a shape of the molded body and improve a performance of the composite solid electrolyte molded body produced using the method according to the present disclosure.

As a molding method for obtaining the molded body, various molding methods may be used. Examples of the molding methods include compression molding, extrusion molding, injection molding, various printing methods, and various coating methods.

The shape of the molded body obtained in the present step is not particularly limited, and generally corresponds to a shape of a target composite solid electrolyte molded body. The molded body obtained in the present step may have a shape and a size that are different from those of the target composite solid electrolyte molded body in consideration of, for example, a portion to be removed in a subsequent step or shrinkage in the heat treatment step.

### 3.2 Heat Treatment Step

In the heat treatment step, the molded body obtained in the molding step is subjected to a heat treatment. Accordingly, the coating layer P12 is converted into a second solid electrolyte which is an oxide, and the composite solid electrolyte molded body containing the first solid electrolyte and the second solid electrolyte is obtained.

The composite solid electrolyte molded body obtained in this manner not only has excellent adhesion between the first solid electrolyte and the second solid electrolyte, but also has excellent adhesion in regions corresponding to the plurality of solid electrolyte composite particles P1. Generation of an unintended gap between the regions can be effectively prevented. Therefore, the obtained composite solid electrolyte molded body is formed of a solid electrolyte having a low grain boundary resistance of a solid electrolyte, an excellent ionic conductivity, and a high denseness.

A heating temperature for the molded body in the heat treatment step is not particularly limited, and is preferably 700° C. or higher and 1000° C. or lower, more preferably 730° C. or higher and 980° C. or lower, and even more preferably 750° C. or higher and 950° C. or lower.

By heating at such a temperature, the obtained composite solid electrolyte molded body can have a sufficiently high denseness, the solid electrolyte composite particles P1, particularly a component such as Li having relatively high volatility, can be more reliably prevented from unintentionally volatilizing during the heating, and the composite solid electrolyte molded body having a desired composition can be more reliably obtained. Performing the heat treatment at a relatively low temperature is also advantageous from viewpoints of energy saving, improvement in productivity of the composite solid electrolyte molded body, and the like.

In the present step, the heating temperature may be changed. For example, the present step may have a first stage in which the heat treatment is performed at a relatively low temperature, and a second stage in which the heat treatment is performed at a relatively high temperature by raising the temperature after the first stage. In such a case, a maximum temperature in the present step is preferably within the ranges described above.

A heating time in the present step is not particularly limited, and is preferably 5 minutes or longer and 300 minutes or shorter, more preferably 10 minutes or longer and 120 minutes or shorter, and even more preferably 15 minutes or longer and 60 minutes or shorter.

Accordingly, the effects described above are more remarkably exhibited.

The present step may be performed in any atmosphere, may be performed in an oxidizing atmosphere such as air or an oxygen gas atmosphere, or may be performed in a non-oxidizing atmosphere of an inert gas such as a nitrogen gas, a helium gas, and an argon gas. The present step may be performed under reduced pressure or vacuum, or may be performed under pressurization. In particular, the present step is preferably performed in an oxidizing atmosphere.

In the present step, the atmosphere may be maintained under substantially the same conditions, or may be changed under different conditions.

Generally, the composite solid electrolyte molded body obtained by using the method for producing a composite solid electrolyte molded body according to the present disclosure is substantially free of the oxo acid compound contained in the solid electrolyte composite particle according to the present disclosure, which is used as a raw material. More specifically, a content of the oxo acid compound in the composite solid electrolyte molded body obtained by using the method for producing a composite solid electrolyte molded body according to the present disclosure is generally 100 ppm or less, more preferably 50 ppm or less, and even more preferably 10 ppm or less.

Accordingly, a content of undesirable impurities in the composite solid electrolyte molded body can be reduced, and characteristics and reliability of the composite solid electrolyte molded body can be improved.

The second solid electrolyte formed in the present step may be different from the constituent material of the coating layer P12, and it is preferable that the first solid electrolyte and the second solid electrolyte are substantially the same.

Accordingly, the adhesion between the first solid electrolyte and the second solid electrolyte in the composite solid electrolyte molded body can be improved, and mechanical strength, shape stability, characteristic stability and reliability of the composite solid electrolyte molded body, and the like can be further improved.

Here, substantially the same refers to that compositions can be considered to be the same.

### 4. Lithium Ion Secondary Battery

Next, a lithium ion secondary battery to which the present disclosure is applied will be described.

The lithium ion secondary battery according to the present disclosure is produced using the above-described solid electrolyte composite particle according to the present disclosure, and can be produced by using, for example, the above-described method for producing a composite solid electrolyte molded body according to the present disclosure.

Such a lithium ion secondary battery has a low grain boundary resistance of a solid electrolyte, an excellent ionic conductivity, and excellent charge and discharge characteristics.

### 4.1 Lithium Ion Secondary Battery According to First Embodiment

Hereinafter, a lithium ion secondary battery according to a first embodiment will be described.

FIG. 2 is a schematic perspective view showing a configuration of the lithium ion secondary battery according to the first embodiment.

As shown in FIG. 2, a lithium ion secondary battery 100 includes a positive electrode 10, and a solid electrolyte layer 20 and a negative electrode 30 that are sequentially stacked on the positive electrode 10. The lithium ion secondary battery 100 further includes a current collector 41 in contact with the positive electrode 10 at a surface side opposite to a surface where the positive electrode 10 faces the solid electrolyte layer 20, and a current collector 42 in contact with the negative electrode 30 at a surface side opposite to a surface where the negative electrode 30 faces the solid electrolyte layer 20. Since each of the positive electrode 10, the solid electrolyte layer 20, and the negative electrode 30 is formed into a solid phase, the lithium ion secondary battery 100 is a chargable and dischargable all-solid battery.

A shape of the lithium ion secondary battery 100 is not particularly limited, and may be a polygonal plate shape or the like. In the configuration shown in the figure, the lithium ion secondary battery 100 has a disc shape. A size of the lithium ion secondary battery 100 is not particularly limited. A diameter of the lithium ion secondary battery 100 is, for example, 10 mm or more and 20 mm or less, and a thickness of the lithium ion secondary battery 100 is, for example, 0.1 mm or more and 1.0 mm or less.

When the lithium ion secondary battery 100 is thus small and thin, the lithium ion secondary battery 100 can be a chargable and dischargable all-solid body, and can be suitably used as a power source for a mobile information terminal such as a smartphone. As will be described later, the lithium ion secondary battery 100 may be used for applications other than the power source of the mobile information terminal.

Hereinafter, configurations of the lithium ion secondary battery 100 will be described.

### 4.1.1 Solid Electrolyte Layer

The solid electrolyte layer 20 is formed using the above-described solid electrolyte composite particle according to the present disclosure.

Accordingly, an ionic conductivity of the solid electrolyte layer 20 is improved. Adhesion of the solid electrolyte layer 20 to the positive electrode 10 and the negative electrode 30 can be improved. As described above, characteristics and reliability of the entire lithium ion secondary battery 100 can be particularly improved.

A thickness of the solid electrolyte layer 20 is not particularly limited, and is preferably 1.1 μm or more and 1,000 μm or less, more preferably 2.5 μm or more and 100 μm or less from a viewpoint of charge and discharge rates.

From a viewpoint of preventing a short circuit between the positive electrode 10 and the negative electrode 30 caused by a dendritic crystal of lithium deposited at a negative electrode 30 side, a value obtained by dividing a measured weight of the solid electrolyte layer 20 by a value obtained by multiplying an apparent volume of the solid electrolyte layer 20 by a theoretical density of a solid electrolyte material, that is, a sintered density, is preferably 50% or more, and more preferably 90% or more.

Examples of a method for forming the solid electrolyte layer 20 include a green sheet method, a press calcination method, and a casting calcination method. A specific example of the method for forming the solid electrolyte layer 20 will be described in detail later. For example, a three-dimensional pattern structure such as a dimple, a trench, or a pillar may be formed on a surface of the solid electrolyte layer 20 in contact with the positive electrode 10 or the negative electrode 30 in order to improve adhesion between the solid electrolyte layer 20 and the positive electrode 10 and adhesion between the solid electrolyte layer 20 and the negative electrode 30, and increase an output or a battery capacity of the lithium ion secondary battery 100 by increasing a specific surface area.

### 4.1.2 Positive Electrode

The positive electrode 10 may be formed of any material as long as the material is a positive electrode active material capable of repeatedly storing and releasing electrochemical lithium ions.

Specifically, the positive electrode active material constituting the positive electrode 10 may be a lithium composite oxide containing at least Li and one or more elements selected from the group consisting of V, Cr, Mn, Fe, Co, Ni, and Cu. Examples of such a composite oxide include LiCoO₂, LiNiO₂, LiMn₂O₄, Li₂Mn₂O₃, LiCr_{0.5}Mn_{0.5}O₂, LiFePO₄, Li₂FeP₂O₇, LiMnPO₄, LiFeBO₃, Li₃V₂ (PO₄)₃, Li₂CuO₂, Li₂FeSiO₄, and Li₂MnSiO₄. Examples of the positive electrode active material constituting the positive electrode 10 include a fluoride such as LiFeF₃, a boride complex compound such as LiBH₄ and Li₄BN₃H₁₀, an iodine complex compound such as a polyvinylpyridine-iodine complex, and a non-metal compound such as sulfur.

In view of a conductivity and an ion diffusion distance, the positive electrode 10 is preferably formed into a thin film on one surface of the solid electrolyte layer 20.

A thickness of the positive electrode 10 formed into a thin film is not particularly limited, and is preferably 0.1 μm or more and 500 μm or less, and more preferably 0.3 μm or more and 100 μm or less.

Examples of a method for forming the positive electrode 10 include a vapor deposition method such as a vacuum deposition method, a sputtering method, a CVD method, a PLD method, an ALD method, and an aerosol deposition method, and a chemical deposition method using a solution such as a sol-gel method and a MOD method. For example, fine particles of the positive electrode active material may be slurried with an appropriate binder, sequeegeeing or screen printing may be performed to form a coating film, and the coating film may be dried and calcined to be baked on the surface of the solid electrolyte layer 20.

### 4.1.3 Negative Electrode

The negative electrode 30 may be formed of any material as long as the material a so-called negative electrode active material that repeatedly stores and releases electrochemical lithium ions at a potential lower than that of the material selected as the positive electrode 10.

Specifically, examples of the negative electrode active material constituting the negative electrode 30 include Nb₂O₅, V₂O₅, TiO₂, In₂O₃, ZnO, SnO₂, NiO, ITO, AZO, GZO, ATO, FTO, and a lithium composite oxide such as Li₄Ti₅O₁₂ and Li₂Ti₃O₇. Examples of the negative electrode active material further include metals and alloys such as Li, Al, Si, Si—Mn, Si—Co, Si—Ni, Sn, Zn, Sb, Bi, In, and Au, a carbon material, and a substance in which lithium ions are inserted between layers of carbon materials, such as LiC₂₄ and LiC₆.

In view of a conductivity and an ion diffusion distance, the negative electrode 30 is preferably formed into a thin film on the other one surface of the solid electrolyte layer 20.

A thickness of the negative electrode 30 formed into a thin film is not particularly limited, and is preferably 0.1 μm or more and 500 μm or less, and more preferably 0.3 μm or more and 100 μm or less.

Examples of a method for forming the negative electrode 30 include a vapor deposition method such as a vacuum deposition method, a sputtering method, a CVD method, a PLD method, an ALD method, and an aerosol deposition method, and a chemical deposition method using a solution such as a sol-gel method and a MOD method. For example, fine particles of the negative electrode active material may be slurried with an appropriate binder, squeegeeing or screen printing may be performed to form a coating film, and the coating film may be dried and calcined to be baked on the surface of the solid electrolyte layer 20.

### 4.1.4 Current Collector

The current collectors 41 and 42 are conductors provided to transfer electrons to and receive electrons from the positive electrode 10 or the negative electrode 30. The current collector is generally formed of a material having a sufficiently small electric resistance and having substantially no change in an electrical conduction characteristic or a mechanical structure during charge and discharge. Specifically, examples of a constituent material of the current collector 41 of the positive electrode 10 include Al, Ti, Pt, and Au. Examples of a constituent material of the current collector 42 of the negative electrode 30 suitably include Cu.

The current collectors 41 and 42 are generally provided to reduce the corresponding contact resistance with respect to the positive electrode 10 or the negative electrode 30. Examples of a shape of the current collectors 41 and 42 include a plate shape and a mesh shape.

A thickness of each of the current collectors 41 and 42 is not particularly limited, and is preferably 7 μm or more and 85 μm or less, and more preferably 10 μm or more and 60 μm or less.

In the configuration shown in the figure, the lithium ion secondary battery 100 includes a pair of current collectors 41 and 42. Alternatively, the lithium ion secondary battery 100 may include only the current collector 41 of the current collectors 41 and 42 when, for example, a plurality of lithium ion secondary batteries 100 are stacked and electrically connected in series.

The lithium ion secondary battery 100 may be used for any application. Examples of an electronic device to which the lithium ion secondary battery 100 is applied as a power source include a personal computer, a digital camera, a mobile phone, a smartphone, a music player, a tablet terminal, a watch, a smart watch, various printers such as an inkjet printer, a television, a projector, a head-up display, wearable terminals such as wireless headphones, wireless earphones, smart glasses, and a head mounted display, a video camera, a video tape recorder, a car navigation device, a drive recorder, a pager, an electronic notebook, an electronic dictionary, an electronic translator, a calculator, an electronic game device, a toy, a word processor, a workstation, a robot, a video phone, a security television monitor, electronic binoculars, a point of sales (POS) terminal, a medical device, a fish finder, various measuring devices, a mobile terminal base station device, various meters and gauges for a vehicle, a railway vehicle, an aircraft, a helicopter, a ship, and the like, a flight simulator, and a network server. The lithium ion secondary battery 100 may also be applied to a moving object such as an automobile and a ship. More specifically, the lithium ion secondary battery 100 can be suitably applied as a storage battery for an electric vehicle, a plug-in hybrid vehicle, a hybrid vehicle, or a fuel cell vehicle. In addition, the lithium ion secondary battery 100 can be applied as a household power source, an industrial power source, a solar power storage battery, and the like.

### 4.2 Lithium Ion Secondary Battery According to Second Embodiment

Next, a lithium ion secondary battery according to a second embodiment will be described.

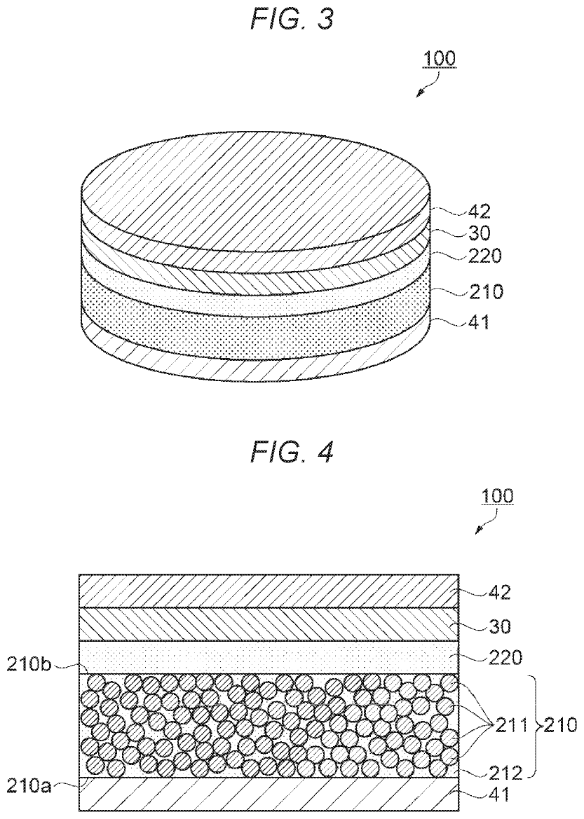

FIG. 3 is a schematic perspective view showing a configuration of the lithium ion secondary battery according to the second embodiment. FIG. 4 is a schematic cross-sectional view showing a structure of the lithium ion secondary battery according to the second embodiment.

Hereinafter, the lithium ion secondary battery according to the second embodiment will be described with reference to the drawings. Differences from the embodiment described above will be mainly described, and description of the same matters will be omitted.

As shown in FIG. 3, the lithium ion secondary battery 100 according to the present embodiment includes a positive electrode mixture 210 functioning as a positive electrode, and an electrolyte layer 220 and the negative electrode 30 that are sequentially stacked on the positive electrode mixture 210. The lithium ion secondary battery 100 further includes the current collector 41 in contact with the positive electrode mixture 210 at a surface side opposite to a surface where the positive electrode mixture 210 faces the electrolyte layer 220, and the current collector 42 in contact with the negative electrode 30 at a surface side opposite to a surface where the negative electrode 30 faces the electrolyte layer 220.

Hereinafter, the positive electrode mixture 210 and the electrolyte layer 220 that are different from the configuration of the lithium ion secondary battery 100 according to the embodiment described above will be described.

### 4.2.1 Positive Electrode Mixture

As shown in FIG. 4, the positive electrode mixture 210 of the lithium ion secondary battery 100 according to the present embodiment includes particulate positive electrode active materials 211 and a solid electrolyte 212. In such a positive electrode mixture 210, an area of an interface where the particulate positive electrode active materials 211 and the solid electrolyte 212 are in contact with each other is increased, so that a battery reaction rate of the lithium ion secondary battery 100 can be further increased.

An average particle diameter of the positive electrode active materials 211 is not particularly limited, and is preferably 0.1 μm or more and 150 μm or less, and more preferably 0.3 μm or more and 60 μm or less.

Accordingly, it is easy to achieve both an actual capacity density close to a theoretical capacity of the positive electrode active materials 211 and high charge and discharge rates.

A particle size distribution of the positive electrode active materials 211 is not particularly limited. For example, in a particle size distribution having one peak, a half width of the peak may be 0.15 μm or more and 19 μm or less. The particle size distribution of the positive electrode active materials 211 may have two or more peaks.

Although a shape of the particulate positive electrode active materials 211 is shown as a spherical shape in FIG. 4, the shape of the positive electrode active materials 211 is not limited to the spherical shape, and may have various forms such as a columnar shape, a plate shape, a scale shape, a hollow shape, and an irregular shape. Alternatively, two or more of the various forms may be combined.

Examples of a constituent material of the positive electrode active materials 211 include materials same as the above-described constituent materials of the positive electrode 10 according to the first embodiment.

Coating layers may be formed on surfaces of the positive electrode active materials 211 in order to reduce an interface resistance with the solid electrolyte 212, improve an electronic conductivity, and the like. An interface resistance of lithium ion conduction can be further reduced by forming a thin film of LiNbO₃, Al₂O₃, ZrO₂, Ta₂O₅, and the like on surfaces of particles of the positive electrode active materials 211 formed of LiCoO₂. A thickness of the coating layer is not particularly limited, and is preferably 3 nm or more and 1 μm or less.

In the present embodiment, the positive electrode mixture 210 contains the solid electrolyte 212 in addition to the positive electrode active materials 211 described above. The solid electrolyte 212 is present so as to fill spaces between the particles of the positive electrode active materials 211, or to be in contact with, particularly in close contact with, the surfaces of the positive electrode active materials 211.

The solid electrolyte 212 is formed using the solid electrolyte composite particle according to the present disclosure.

Accordingly, an ionic conductivity of the solid electrolyte 212 is particularly improved. Adhesion of the solid electrolyte 212 to the positive electrode active materials 211 or the electrolyte layer 220 is improved. As described above, characteristics and reliability of the entire lithium ion secondary battery 100 can be particularly improved.

When a content of the positive electrode active materials 211 in the positive electrode mixture 210 is XA (mass %) and a content of the solid electrolyte 212 in the positive electrode mixture 210 is XS (mass %), it is preferable to satisfy a relationship of 0.1≤XS/XA≤8.3, more preferable to satisfy a relationship of 0.3≤XS/XA≤2.8, and even more preferable to satisfy a relationship of 0.6≤XS/XA≤1.4.

In addition to the positive electrode active materials 211 and the solid electrolyte 212, the positive electrode mixture 210 may contain a conductive auxiliary and a binder.

The conductive auxiliary may be any conductor as long as the conductor can ignore electrochemical interaction at a positive electrode reaction potential. More specifically, examples of the conductive auxiliary include carbon materials such as acetylene black, Ketjen black, and carbon nanotubes, precious metals such as palladium and platinum, and conductive oxides such as SnO₂, ZnO, RuO₂ or ReO₃, and Ir₂O₃.

A thickness of the positive electrode mixture 210 is not particularly limited, and is preferably 1.1 μm or more and 500 μm or less, and more preferably 2.3 μm or more and 100 μm or less.

### 4.2.2 Electrolyte Layer

The electrolyte layer 220 is preferably formed of a material that is the same as or is the same type as the material of the solid electrolyte 212 from a viewpoint of an interface impedance between the electrolyte layer 220 and the positive electrode mixture 210. Alternatively, the electrolyte layer 220 may be formed of a material different from the material of the solid electrolyte 212. For example, the electrolyte layer 220 may be formed of a material having a composition different from a composition of the solid electrolyte 212 formed using the above-described solid electrolyte composite particle according to the present disclosure. The electrolyte layer 220 may be another oxide solid electrolyte not formed of the solid electrolyte composite particle according to the present disclosure, for example, a sulfide solid electrolyte, a nitride solid electrolyte, a halide solid electrolyte, a hydride solid electrolyte, a dry polymer electrolyte, and a quasi-solid electrolyte crystalline material or amorphous material. The electrolyte layer 220 may be formed of a material obtained by combining two or more types of materials selected from above.

Examples of an oxide of the crystalline material include: a perovskite type crystal or a perovskite-like crystal in which a part of elements constituting Li_{0.35}La_{0.55}TiO₃ and Li_{0.2}La_{0.27}NbO₃ and crystals thereof is substituted by N, F, Al, Sr, Sc, Nb, Ta, Sb, a lanthanoid element, and the like; a garnet type crystal or a garnet-like crystal in which a part of elements constituting Li₇La₃Zr₂O₁₂, Li₅La₃Nb₂O₁₂, Li₅BaLa₂TaO₁₂ and crystals thereof is substituted by N, F, Al, Sr, Sc, Nb, Ta, Sb, a lanthanoid element, and the like; a NASICON type crystal in which a part of elements constituting Li_{1.3}Ti_{1.7}Al_{0.3}(PO₄)₃, Li_{1.4}Al_{0.4}Ti_{1.6}(PO₄)₃, Li_{1.4}Al_{0.4}Ti_{1.4}Ge_{0.2}(PO₄)₃ and crystals thereof is substituted by N, F, Al, Sr, Sc, Nb, Ta, Sb, a lanthanoid element, and the like; a LISICON type crystal such as Li₁₄ZnGe₄O₁₆; and other crystalline materials such as Li_{3.4}V_{0.6}Si_{0.4}O₄, Li_{3.6}V_{0.4}Ge_{0.6}O₄, and Li₂₊ₓC₁₋ₓBₓO₃.

Examples of a sulfide of the crystalline material include Li₁₀GeP₂S₁₂, Li_{9.6}P₃S₁₂, Li_{9.54}Si_{1.74}P_{1.44}S_{11.7}Cl_{0.3}, and Li₃PS₄.

Examples of other amorphous materials include Li₂O—TiO₂, La₂O₃—Li₂O—TiO₂, LiNbO₃, LiSO₄, Li₄SiO₄, Li₃PO₄—Li₄SiO₄, Li₄GeO₄—Li₃VO₄, Li₄SiO₄—Li₃VO₄, Li₄GeO₄—Zn₂GeO₂, Li₄SiO₄—LiMoO₄, Li₄SiO₄—Li₄ZrO₄, SiO₂—P₂O₅—Li₂O, SiO₂—P₂O₅—LiCl, Li₂O—LiCl—B₂O₃, LiAlCl₄, LiAlF₄, LiF—Al₂O₃, LiBr—Al₂O₃, Li_{2.88}PO_{3.73}N_{0.14}, Li₃N—LiCl, Li₆NBr₃, Li₂S—SiS₂, and Li₂S—SiS₂—P₂S₅.

When the electrolyte layer 220 is formed of a crystalline material, the crystalline material preferably has a crystal structure such as a cubic crystal having small crystal surface anisotropy in a direction of lithium ion conduction. When the electrolyte layer 220 is formed of an amorphous material, anisotropy of lithium ion conduction is reduced. Therefore, any one of the crystalline materials and the amorphous materials described above is preferably used as a solid electrolyte constituting the electrolyte layer 220.

A thickness of the electrolyte layer 220 is preferably 1.1 μm or more and 100 μm or less, and more preferably 2.5 μm or more and 10 μm or less. When the thickness of the electrolyte layer 220 is within the above range, an internal resistance of the electrolyte layer 220 can be further reduced, and an occurrence of a short circuit between the positive electrode mixture 210 and the negative electrode 30 can be more effectively prevented.

For example, a three-dimensional pattern structure such as a dimple, a trench, or a pillar may be formed, for example, on a surface of the electrolyte layer 220 in contact with the negative electrode 30 in order to improve adhesion between the electrolyte layer 220 and the negative electrode 30, and increase an output or a battery capacity of the lithium ion secondary battery 100 by increasing a specific surface area.

### 4.3 Lithium Ion Secondary Battery According to Third Embodiment

Next, a lithium ion secondary battery according to a third embodiment will be described.

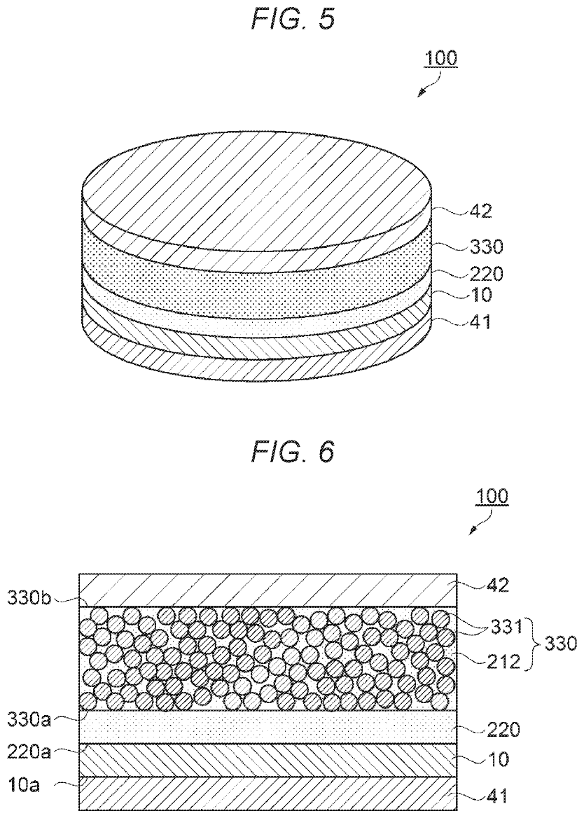

FIG. 5 is a schematic perspective view showing a configuration of the lithium ion secondary battery according to the third embodiment. FIG. 6 is a schematic cross-sectional view showing a structure of the lithium ion secondary battery according to the third embodiment.

Hereinafter, the lithium ion secondary battery according to the third embodiment will be described with reference to the drawings. Differences from the embodiments described above will be mainly described, and description of the same matters will be omitted.

As shown in FIG. 5, the lithium ion secondary battery 100 according to the present embodiment includes the positive electrode 10, the electrolyte layer 220, and a negative electrode mixture 330 functioning as a negative electrode. The electrolyte layer 220 and the negative electrode mixture 330 are sequentially stacked on the positive electrode 10. The lithium ion secondary battery 100 further includes the current collector 41 in contact with the positive electrode 10 at a surface side opposite to a surface where the positive electrode 10 faces the electrolyte layer 220, and the current collector 42 in contact with the negative electrode mixture 330 at a surface side opposite to a surface where the negative electrode mixture 330 faces the electrolyte layer 220.

Hereinafter, the negative electrode mixture 330 different from the configuration of the lithium ion secondary battery 100 according to the embodiments described above will be described.

### 4.3.1 Negative Electrode Mixture

As shown in FIG. 6, the negative electrode mixture 330 of the lithium ion secondary battery 100 according to the present embodiment includes particulate negative electrode active materials 331 and the solid electrolyte 212. In such a negative electrode mixture 330, an area of an interface where the particulate negative electrode active materials 331 and the solid electrolyte 212 are in contact with each other is increased, so that a battery reaction rate of the lithium ion secondary battery 100 can be further increased.

An average particle diameter of the negative electrode active materials 331 is not particularly limited, and is preferably 0.1 μm or more and 150 μm or less, and more preferably 0.3 μm or more and 60 μm or less.

Accordingly, it is easy to achieve both an actual capacity density close to a theoretical capacity of the negative electrode active materials 331 and high charge and discharge rates.

A particle size distribution of the negative electrode active materials 331 is not particularly limited. For example, in a particle size distribution having one peak, a half width of the peak may be 0.1 μm or more and 18 μm or less. The particle size distribution of the negative electrode active materials 331 may have two or more peaks.

Although a shape of the particulate negative electrode active materials 331 is shown as a spherical shape in FIG. 6, the shape of the negative electrode active materials 331 is not limited to the spherical shape, and may have various forms such as a columnar shape, a plate shape, a scale shape, a hollow shape, and an irregular shape. Alternatively, two or more of the various forms may be combined.

Examples of constituent materials of the negative electrode active materials 331 include materials same as the above-described constituent materials of the negative electrode 30 according to the first embodiment.

In the present embodiment, the negative electrode mixture 330 contains the solid electrolyte 212 in addition to the negative electrode active materials 331 described above. The solid electrolyte 212 is present so as to fill spaces between particles of the negative electrode active materials 331, or to be in contact with, particularly in close contact with, surfaces of the negative electrode active materials 331.

The solid electrolyte 212 is formed using the solid electrolyte composite particle according to the present disclosure.

Accordingly, an ionic conductivity of the solid electrolyte 212 is particularly improved. Adhesion of the solid electrolyte layer 212 to the negative electrode active materials 331 or the electrolyte layer 220 can be improved. As described above, characteristics and reliability of the entire lithium ion secondary battery 100 can be particularly improved.

When a content of the negative electrode active materials 331 in the negative electrode mixture 330 is XB (mass %) and a content of the solid electrolyte 212 in the negative electrode mixture 330 is XS (mass %), it is preferable to satisfy a relationship of 0.14≤XS/XB≤26, more preferable to satisfy a relationship of 0.44≤XS/XB≤4.1, and even more preferable to satisfy a relationship of 0.89≤XS/XB≤2.1.

In addition to the negative electrode active materials 331 and the solid electrolyte 212, the negative electrode mixture 330 may contain a conductive auxiliary and a binder.

The conductive auxiliary may be any conductor as long as the conductor can ignore electrochemical interaction at a positive electrode reaction potential. More specifically, examples of the conductive auxiliary include carbon materials such as acetylene black, Ketjen black, and carbon nanotubes, precious metals such as palladium and platinum, and conductive oxides such as SnO₂, ZnO, RuO₂ or ReO₃, and Ir₂O₃.

A thickness of the negative electrode mixture 330 is not particularly limited, and is preferably 1.1 μm or more and 500 μm or less, and more preferably 2.3 μm or more and 100 μm or less.

### 4.4 Lithium Ion Secondary Battery According to Fourth Embodiment

Next, a lithium ion secondary battery according to a fourth embodiment will be described.

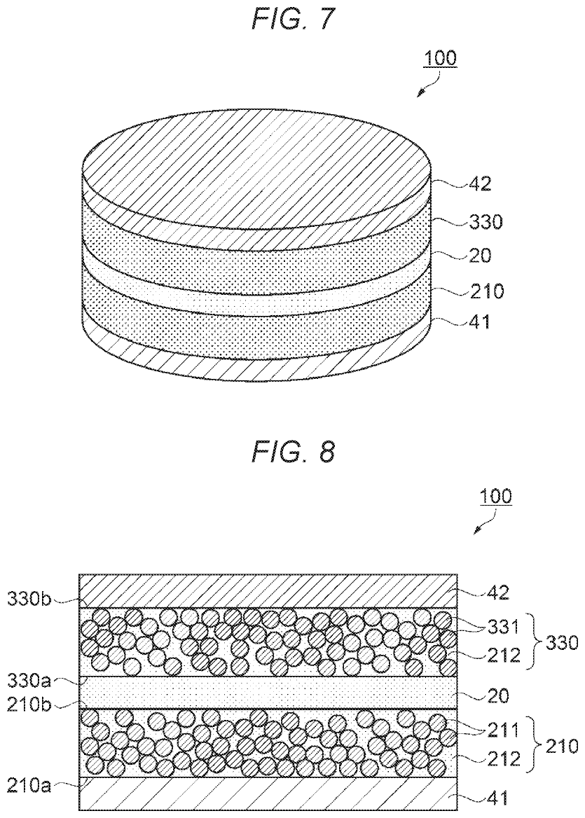

FIG. 7 is a schematic perspective view showing a configuration of the lithium ion secondary battery according to the fourth embodiment. FIG. 8 is a schematic cross-sectional view showing a structure of the lithium ion secondary battery according to the fourth embodiment.

Hereinafter, the lithium ion secondary battery according to the fourth embodiment will be described with reference to the drawings. Differences from the embodiments described above will be mainly described, and description of the same matters will be omitted.

As shown in FIG. 7, the lithium ion secondary battery 100 according to the present embodiment includes the positive electrode mixture 210, and the solid electrolyte layer 20 and the negative electrode mixture 330 that are sequentially stacked on the positive electrode mixture 210. The lithium ion secondary battery 100 further includes the current collector 41 in contact with the positive electrode mixture 210 at a surface side opposite to a surface where the positive electrode mixture 210 faces the solid electrolyte layer 20, and the current collector 42 in contact with the negative electrode mixture 330 at a surface side opposite to a surface where the negative electrode mixture 330 faces the solid electrolyte layer 20.

These configurations preferably satisfy the same condition as those described for corresponding configurations in the embodiments described above.

In the first to fourth embodiments, another layer may be provided between layers constituting the lithium ion secondary battery 100 or on surfaces of the layers. Examples of such a layer include an adhesive layer, an insulation layer, and a protective layer.

### 5. Method for Producing Lithium Ion Secondary Battery

Next, a method for producing the above-described lithium ion secondary battery will be described.

In the method for producing the lithium ion secondary battery according to the present disclosure, the above-described method for producing the composite solid electrolyte molded body according to the present disclosure using the above-described solid electrolyte composite particle according to the present disclosure can be applied.

### 5.1 Method for Producing Lithium Ion Secondary Battery According to First Embodiment

Next, a method for producing the lithium ion secondary battery according to the first embodiment will be described.

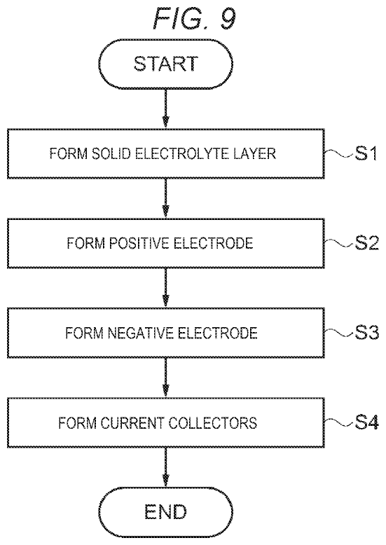

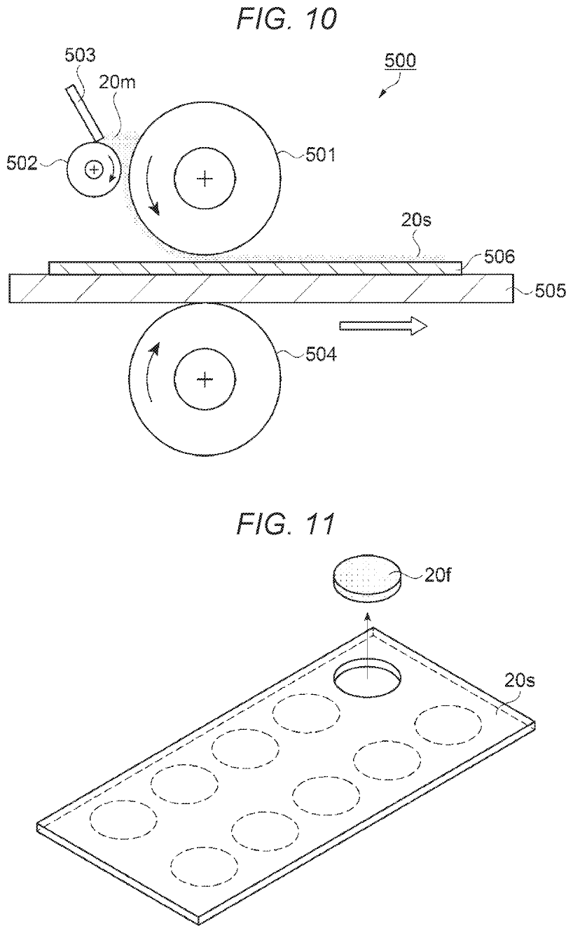

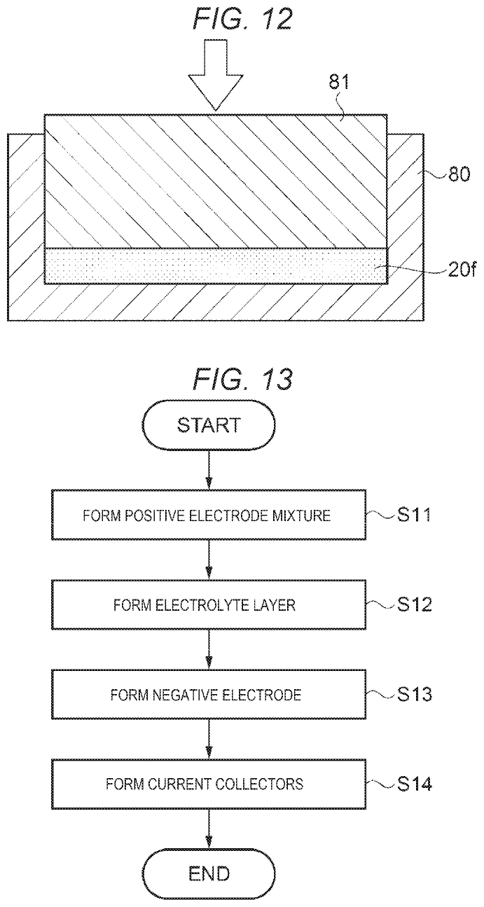

FIG. 9 is a flowchart showing the method for producing the lithium ion secondary battery according to the first embodiment. FIGS. 10 and 11 are schematic views showing the method for producing the lithium ion secondary battery according to the first embodiment. FIG. 12 is a schematic cross-sectional view showing another method for forming a solid electrolyte layer.

As shown in FIG. 9, the method for producing the lithium ion secondary battery 100 according to the present embodiment includes step S1, step S2, step S3, and step S4.

Step S1 is a step of forming the solid electrolyte layer 20. Step S2 is a step of forming the positive electrode 10. Step S3 is a step of forming the negative electrode 30. Step S4 is a step of forming the current collectors 41 and 42.

### 5.1.1 Step S1

In the step of forming the solid electrolyte layer 20 in step S1, the solid electrolyte layer 20 is formed by, for example, a green sheet method using the solid electrolyte composite particle according to the present disclosure. More specifically, the solid electrolyte layer 20 can be formed as follows.

That is, first, a solution in which a binder such as polypropylene carbonate is dissolved in a solvent such as 1,4-dioxane is prepared, and the solution and the solid electrolyte composite particle according to the present disclosure are mixed to obtain a slurry 20m. The slurry 20m may be prepared by further using a dispersant, a diluent, a moisturizer, or the like as needed.

Next, a solid electrolyte layer forming sheet 20s is formed using the slurry 20m. More specifically, as shown in FIG. 10, the slurry 20m is applied, by using, for example, a fully automatic film applicator 500, at a predetermined thickness onto a substrate 506 such as a polyethylene terephthalate film to form the solid electrolyte layer forming sheet 20s. The fully automatic film applicator 500 includes an application roller 501 and a doctor roller 502. A squeegee 503 is provided so as to be in contact with the doctor roller 502 from above. A transport roller 504 is provided at a position facing the application roller 501 from below. A stage 505 on which the substrate 506 is placed is inserted between the application roller 501 and the transport roller 504 so as to be transported in a predetermined direction. The slurry 20m is charged to a side where the squeegee 503 is provided between the application roller 501 and the doctor roller 502 arranged with a gap in a transport direction of the stage 505. The application roller 501 and the doctor roller 502 are rotated so as to push the slurry 20m downward from the gap, and the slurry 20m having a predetermined thickness is applied on a surface of the application roller 501. At the same time, the transport roller 504 is rotated and the stage 505 is transported to bring the substrate 506 into contact with the application roller 501 on which the slurry 20m is applied. Accordingly, the slurry 20m applied on the application roller 501 is transferred onto the substrate 506 in a sheet shape, to obtain the solid electrolyte layer forming sheet 20s.

Thereafter, the solvent is removed from the solid electrolyte layer forming sheet 20s formed on the substrate 506, and the solid electrolyte layer forming sheet 20s is peeled off from the substrate 506. As shown FIG. 11, the solid electrolyte layer forming sheet 20s is punched into a predetermined size using a punching die, and a molded object 20f is formed. This treatment corresponds to the molding step in the method for producing a composite solid electrolyte molded body according to the present disclosure.

Thereafter, a heating step of heating the molded object 20f is performed to obtain the solid electrolyte layer 20 as a main calcined body. This treatment corresponds to the heat treatment step in the method for producing a composite solid electrolyte molded body according to the present disclosure. Therefore, this treatment is preferably performed under the same conditions as those described in [3.2 Heat Treatment Step] described above. Accordingly, the same effects as those described above can be obtained.

The slurry 20m may be pressed and pushed by the application roller 501 and the doctor roller 502 to form the solid electrolyte layer forming sheet 20s having a predetermined thickness, so that a sintered density of the solid electrolyte layer 20 after calcination is 90% or more.

### 5.1.2 Step S2

The method proceeds to step S2 after step S1.

In the step of forming the positive electrode 10 in step S2, the positive electrode 10 is formed on one surface of the solid electrolyte layer 20. More specifically, for example, first, a sputtering device is used to perform sputtering using LiCoO₂ as a target in an inert gas such as an argon gas, thereby forming a LiCoO₂ layer on the surface of the solid electrolyte layer 20. Thereafter, the LiCoO₂ layer formed on the solid electrolyte layer 20 is calcined in an oxidizing atmosphere to convert a crystal of the LiCoO₂ layer into a high temperature phase crystal, and the LiCoO₂ layer can be formed as the positive electrode 10. A calcination condition for the LiCoO₂ layer is not particularly limited. A heating temperature may be 400° C. or higher and 600° C. or lower, and a heating time may be 1 hour or longer and 3 hours or shorter.

### 5.1.3 Step S3

The method proceeds to step S3 after step S2.

In the step of forming the negative electrode 30 in step S3, the negative electrode 30 is formed on the other surface of the solid electrolyte layer 20, that is, on a surface opposite to the surface where the positive electrode is formed. More specifically, for example, a vacuum deposition device is used to form a thin film of metal Li on the surface of the solid electrolyte layer 20 that is opposite to the surface where the positive electrode 10 is formed, so that the negative electrode 30 can be formed. A thickness of the negative electrode 30 may be, for example, 0.1 μm or more and 500 μm or less.

### 5.1.4 Step S4

The method proceeds to step S4 after step S3.

In the step of forming the current collectors 41 and 42 in step S4, the current collector 41 is formed to be in contact with the positive electrode 10 and the current collector 42 is formed to be in contact with the negative electrode 30. More specifically, an aluminum foil having a circular shape formed by die cutting or the like can be pressed against and joined with the positive electrode 10, and the current collector 41 can be formed. A copper foil having a circular shape formed by die cutting or the like can be pressed against and joined with the negative electrode 30, and the current collector 42 can be formed. A thickness of each of the current collectors 41 and 42 is not particularly limited, and may be, for example, 10 μm or more and 60 μm or less. Only one of the current collectors 41 and 42 may be formed in the present step.

The method for forming the solid electrolyte layer 20 is not limited to the green sheet method shown in step S1. The following method or the like can be adopted as another method for forming the solid electrolyte layer 20. That is, as shown in FIG. 12, the molded object 20f may be obtained by filling the solid electrolyte composite particle according to the present disclosure in a powder form into a pellet die 80, closing the pellet die using a lid 81, and pressing the lid 81 to perform uniaxial press molding. Thereafter, a treatment for the molded object 20f may be performed in the same manner as described above. A die having an exhaust port (not shown) can be suitably used as the pellet die 80.

### 5.2 Method for Producing Lithium Ion Secondary Battery According to Second Embodiment

Next, a method for producing the lithium ion secondary battery according to the second embodiment will be described.

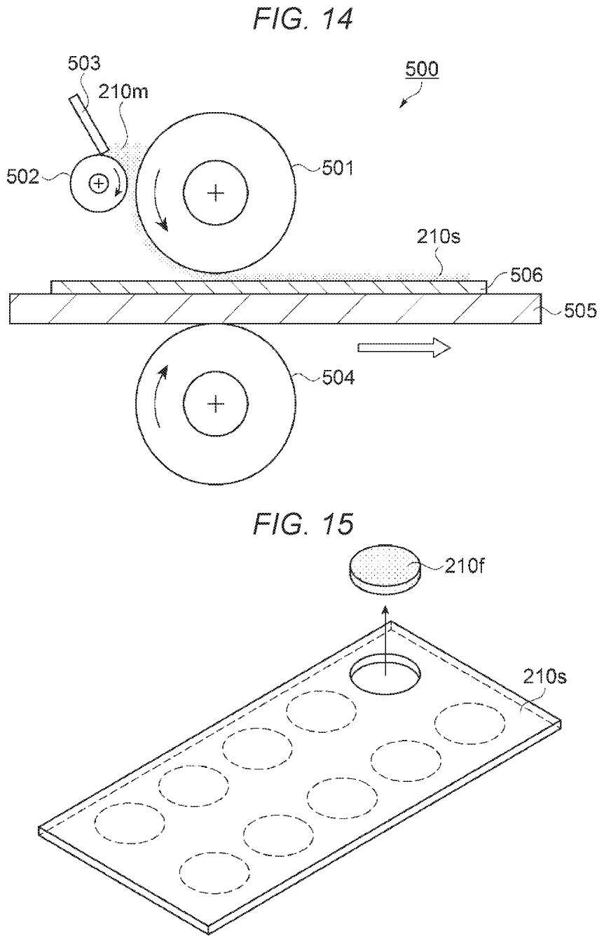

FIG. 13 is a flowchart showing the method for producing the lithium ion secondary battery according to the second embodiment. FIGS. 14 and 15 are schematic views showing the method for producing the lithium ion secondary battery according to the second embodiment.

Hereinafter, the method for producing the lithium ion secondary battery according to the second embodiment will be described with reference to the drawings. Differences from the embodiment described above will be mainly described, and description of the same matters will be omitted.

As shown in FIG. 13, the method for producing the lithium ion secondary battery 100 according to the present embodiment includes step S11, step S12, step S13, and step S14.

Step S11 is a step of forming the positive electrode mixture 210. Step S12 is a step of forming the electrolyte layer 220. Step S13 is a step of forming the negative electrode 30. Step S14 is a step of forming the current collectors 41 and 42.

### 5.2.1 Step S11

In the step of forming the positive electrode mixture 210 in step S11, the positive electrode mixture 210 is formed.

For example, the positive electrode mixture 210 can be formed as follows.

That is, first, a slurry 210m which is a mixture of the positive electrode active materials 211 such as LiCoO₂, the solid electrolyte composite particle according to the present disclosure, a binder such as polypropylene carbonate, and a solvent such as 1,4-dioxane is obtained. The slurry 210m may be prepared by further using a dispersant, a diluent, a moisturizer, or the like as needed.

Next, a positive electrode mixture forming sheet 210s is formed using the slurry 210m. More specifically, as shown in FIG. 14, the slurry 210m is applied, by using, for example, the fully automatic film applicator 500, at a predetermined thickness onto the substrate 506 such as a polyethylene terephthalate film to form the positive electrode mixture forming sheet 210s.

Thereafter, the solvent is removed from the positive electrode mixture forming sheet 210s formed on the substrate 506, and the positive electrode mixture forming sheet 210s is peeled off from the substrate 506. As shown FIG. 15, the positive electrode mixture forming sheet 210s is punched into a predetermined size using a punching die, and a molded object 210f is formed. This treatment corresponds to the molding step in the method for producing a composite solid electrolyte molded body according to the present disclosure.

Thereafter, a heating step of heating the molded object 210f is performed to obtain the positive electrode mixture 210 containing a solid electrolyte. This treatment corresponds to the heat treatment step in the method for producing a composite solid electrolyte molded body according to the present disclosure. Therefore, this treatment is preferably performed under the same conditions as those described in [3.2 Heat Treatment Step] described above. Accordingly, the same effects as those described above can be obtained.

### 5.2.2 Step S12

The method proceeds to step S12 after step S11.

In the step of forming the electrolyte layer 220 in step S12, the electrolyte layer 220 is formed on one surface 210b of the positive electrode mixture 210. More specifically, for example, a sputtering device is used to perform sputtering using LLZSTO (Li_{6.3}La₃Zr_{1.3}Sb_{0.5}Ta_{0.2}O₇) as a target in an inert gas such as an argon gas, thereby forming an LLZSTO layer on the surface of the positive electrode mixture 210. Thereafter, the LLZSTO layer formed on the positive electrode mixture 210 is calcined in an oxidizing atmosphere to convert a crystal of the LLZSTO layer into a high temperature phase crystal, and the LLZSTO layer can be formed as the electrolyte layer 220. A calcination condition for the LLZSTO layer is not particularly limited. A heating temperature may be 500° C. or higher and 900° C. or lower, and a heating time may be 1 hour or longer and 3 hours or shorter.

### 5.2.3 Step S13

The method proceeds to step S13 after step S12.

In the step of forming the negative electrode 30 in step S13, the negative electrode 30 is formed at a surface side opposite to a surface where the electrolyte layer 220 faces the positive electrode mixture 210. More specifically, for example, a vacuum deposition device is used to form a thin film of metal Li at the surface side opposite to a surface where the electrolyte layer 220 faces the positive electrode mixture 210, so that the negative electrode 30 can be formed.

### 5.2.4 Step S14

The method proceeds to step S14 after step S13.

In the step of forming the current collectors 41 and 42 in step S14, the current collector 41 is formed to be in contact with the other surface of the positive electrode mixture 210, that is, a surface 210a at a side opposite to the surface 210b on which the electrolyte layer 220 is formed, and the current collector 42 is formed to be in contact with the negative electrode 30.

The method for forming the positive electrode mixture 210 and the electrolyte layer 220 is not limited to the method described above. For example, the positive electrode mixture 210 and the electrolyte layer 220 may be formed as follows. First, a slurry which is a mixture of the solid electrolyte composite particle according to the present disclosure, a binder, and a solvent is obtained. Then, the obtained slurry is charged into the fully automatic film applicator 500, and applied onto the substrate 506 to form an electrolyte forming sheet. Thereafter, the electrolyte forming sheet and the positive electrode mixture forming sheet 210s formed in the same manner as described above are pressed in a stacked state and are bonded together. Thereafter, a stacked sheet obtained by bonding can be die-cut into a molded object, and the molded object can be calcined in an oxidizing atmosphere, to obtain a stacked body including the positive electrode mixture 210 and the electrolyte layer 220.

### 5.3 Method for Producing Lithium Ion Secondary Battery According to Third Embodiment

Next, a method for producing the lithium ion secondary battery according to the third embodiment will be described.

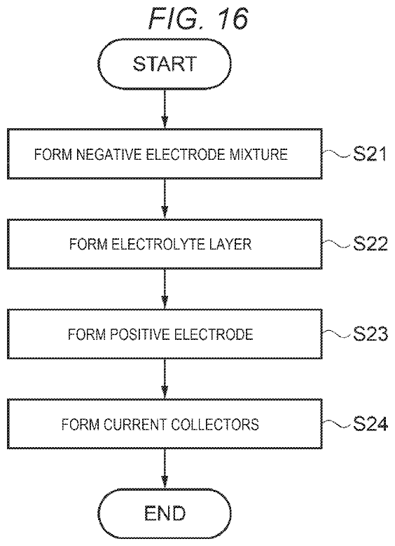

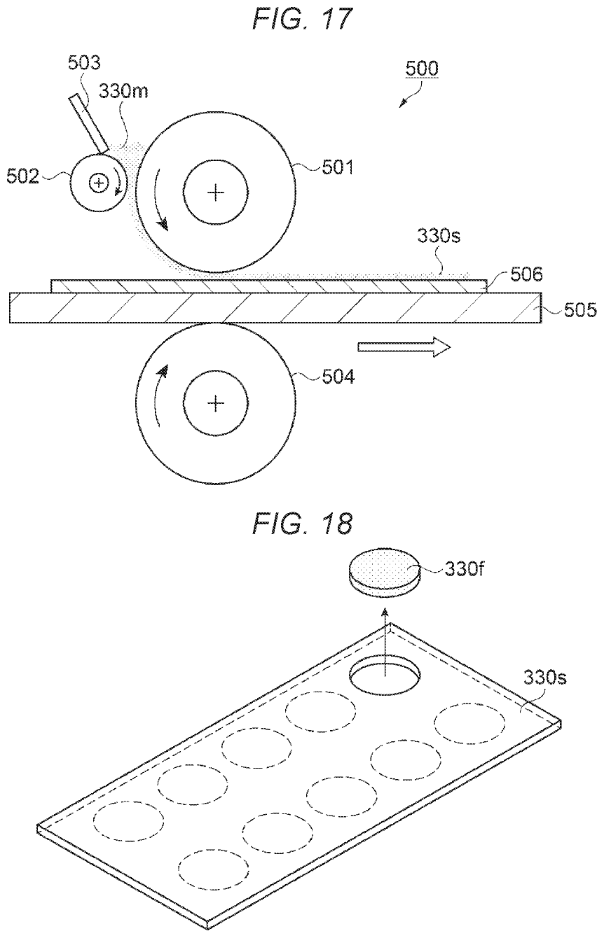

FIG. 16 is a flowchart showing the method for producing the lithium ion secondary battery according to the third embodiment. FIGS. 17 and 18 are schematic views showing the method for producing the lithium ion secondary battery according to the third embodiment.

Hereinafter, the method for producing the lithium ion secondary battery according to the third embodiment will be described with reference to the drawings. Differences from the embodiments described above will be mainly described, and description of the same matters will be omitted.

As shown in FIG. 16, the method for producing the lithium ion secondary battery 100 according to the present embodiment includes step S21, step S22, step S23, and step S24.

Step S21 is a step of forming the negative electrode mixture 330. Step S22 is a step of forming the electrolyte layer 220. Step S23 is a step of forming the positive electrode 10. Step S24 is a step of forming the current collectors 41 and 42.

### 5.3.1 Step S21

In the step of forming the negative electrode mixture 330 in step S21, the negative electrode mixture 330 is formed.

For example, the negative electrode mixture 330 can be formed as follows.

That is, first, a slurry 330m which is a mixture of the negative electrode active materials 331 such as Li₄Ti₅O₁₂, the solid electrolyte composite particles according to the present disclosure, a binder such as polypropylene carbonate, and a solvent such as 1,4-dioxane is obtained. The slurry 330m may be prepared by further using a dispersant, a diluent, a moisturizer, or the like as needed.

Next, a negative electrode mixture forming sheet 330s is formed using the slurry 330m. More specifically, as shown in FIG. 17, the slurry 330m is applied, by using, for example, the fully automatic film applicator 500, at a predetermined thickness onto the substrate 506 such as a polyethylene terephthalate film to form the negative electrode mixture forming sheet 330s.

Thereafter, the solvent is removed from negative electrode mixture forming sheet 330s formed on the substrate 506, and the negative electrode mixture forming sheet 330s is peeled off from the substrate 506. As shown FIG. 18, the negative electrode mixture forming sheet 330s is punched into a predetermined size using a punching die, and a molded object 330f is formed. This treatment corresponds to the molding step in the method for producing a composite solid electrolyte molded body according to the present disclosure.

Thereafter, a heating step of heating the molded object 330f is performed to obtain the negative electrode mixture 330 containing a solid electrolyte. This treatment corresponds to the heat treatment step in the method for producing a composite solid electrolyte molded body according to the present disclosure. Therefore, this treatment is preferably performed under the same conditions as those described in [3.2 Heat Treatment Step] described above. Accordingly, the same effects as those described above can be obtained.

### 5.3.2 Step S22

The method proceeds to step S22 after step S21.

In the step of forming the electrolyte layer 220 in step S22, the electrolyte layer 220 is formed on one surface 330a of the negative electrode mixture 330. More specifically, for example, a sputtering device is used to perform sputtering using a solid solution Li_{2.2}C_{0.8}B_{0.2}O₃ of Li₂CO₃ and Li₃BO₃ as a target in an inert gas such as an argon gas, thereby forming a Li_{2.2}C_{0.8}B_{0.2}O₃ layer on the surface of the negative electrode mixture 330. Thereafter, the Li_{2.2}C_{0.8}B_{0.2}O₃ layer formed on the negative electrode mixture 330 is calcined in an oxidizing atmosphere to convert a crystal of the Li_{2.2}C_{0.8}B_{0.2}O₃ layer into a high temperature phase crystal, and the Li_{2.2}C_{0.8}B_{0.2}O₃ layer can be formed as the electrolyte layer 220. A calcination condition for the Li_{2.2}C_{0.8}B_{0.2}O₃ layer is not particularly limited. A heating temperature may be 400° C. or higher and 600° C. or lower, and a heating time may be 1 hour or longer and 3 hours or lower.

### 5.3.3 Step S23

The method proceeds to step S23 after step S22.

In the step of forming the positive electrode 10 in step S23, the positive electrode 10 is formed at one surface 220a side of the electrolyte layer 220, that is, at a surface side opposite to a surface where the electrolyte layer 220 faces the negative electrode mixture 330. More specifically, first, a LiCoO₂ layer is formed on the surface 220a of the electrolyte layer 220 by using a vacuum deposition device or the like. Thereafter, a stacked body including the electrolyte layer 220 on which the LiCoO₂ layer is formed and the negative electrode mixture 330 is calcined to convert a crystal of the LiCoO₂ layer into a high temperature phase crystal, and the LiCoO₂ layer can be formed as the positive electrode 10. A calcination condition for the LiCoO₂ layer is not particularly limited. A heating temperature may be 400° C. or higher and 600° C. or lower, and a heating time may be 1 hour or longer and 3 hours or shorter.

### 5.3.4 Step S24

The method proceeds to step S24 after step S23.

In the step of forming the current collectors 41 and 42 in step S24, the current collector 41 is formed to be in contact with one surface 10a of the positive electrode 10, that is, the surface 10a at a side opposite to a surface of the positive electrode 10 where the electrolyte layer 220 is formed, and the current collector 42 is formed to be in contact with the other surface of the negative electrode mixture 330, that is, a surface 330b at a side opposite to the surface 330a of the negative electrode mixture 330 where the electrolyte layer 220 is formed.

The method for forming the negative electrode mixture 330 and the electrolyte layer 220 is not limited to the method described above. For example, the negative electrode mixture 330 and the electrolyte layer 220 may be formed as follows. First, a slurry which is a mixture of the solid electrolyte composite particle according to the present disclosure, a binder, and a solvent is obtained. Then, the obtained slurry is charged into the fully automatic film applicator 500, and applied onto the substrate 506 to form an electrolyte forming sheet. Thereafter, the electrolyte forming sheet and the negative electrode mixture forming sheet 330s formed in the same manner as described above are pressed in a stacked state and are bonded together. Thereafter, a stacked sheet obtained by bonding can be die-cut into a molded object, and the molded object is calcined in an oxidizing atmosphere, to obtain a stacked body including the negative electrode mixture 330 and the electrolyte layer 220.

### 5.4 Method for Producing Lithium Ion Secondary Battery

### According to Fourth Embodiment

Next, a method for producing the lithium ion secondary battery according to the fourth embodiment will be described.

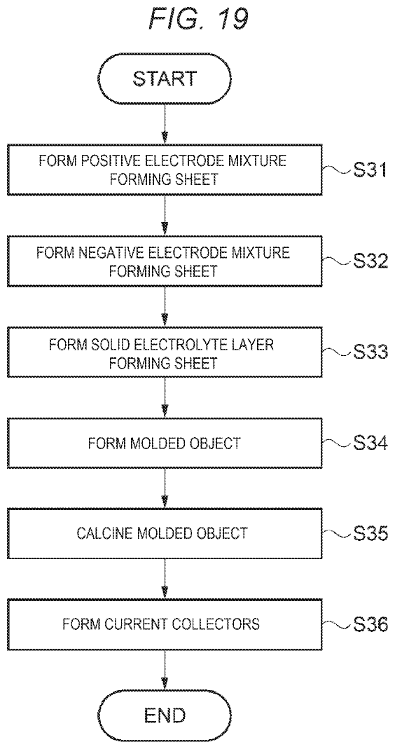

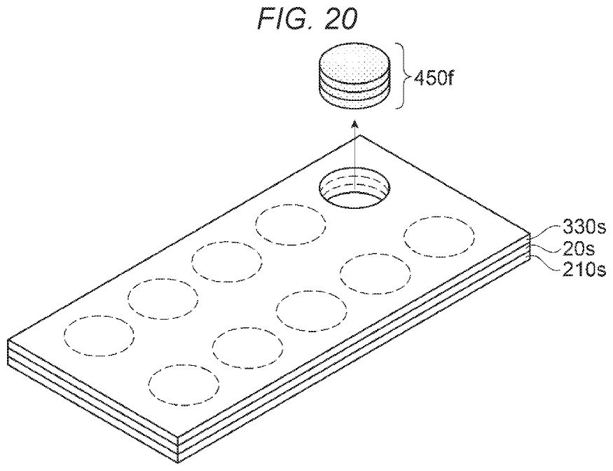

FIG. 19 is a flowchart showing the method for producing the lithium ion secondary battery according to the fourth embodiment. FIG. 20 is a schematic view showing the method for producing the lithium ion secondary battery according to the fourth embodiment.

Hereinafter, the method for producing the lithium ion secondary battery according to the fourth embodiment will be described with reference to the drawings. Differences from the embodiments described above will be mainly described, and description of the same matters will be omitted.

As shown in FIG. 19, the method for producing the lithium ion secondary battery 100 according to the present embodiment includes step S31, step S32, step S33, step S34, step S35, and step S36.

Step S31 is a step of forming a positive electrode mixture 210 forming sheet. Step S32 is a step of forming a negative electrode mixture 330 forming sheet. Step S33 is a step of forming a solid electrolyte layer 20 forming sheet. Step S34 is a step of forming a molded object 450f obtained by molding a stacked body including the positive electrode mixture 210 forming sheet, the negative electrode mixture 330 forming sheet, and the solid electrolyte layer 20 forming sheet into a predetermined shape. Step S35 is a step of calcining the molded object 450f. Step S36 is a step of forming the current collectors 41 and 42.

In the following description, step S32 is performed after step S31, and step S33 is performed after step S32. The method is not limited to being performed in order of step S31, step S32, and step S33. The order may be changed, or step S31, step S32, and step S33 may be performed simultaneously.

### 5.4.1 Step S31

In the step of forming the positive electrode mixture 210 forming sheet in step S31, the positive electrode mixture forming sheet 210s which is the positive electrode mixture 210 forming sheet is formed.

The positive electrode mixture forming sheet 210s can be formed by, for example, the method same as the method described in the second embodiment.

The positive electrode mixture forming sheet 210s obtained in the present step is preferably obtained by removing the solvent from the slurry 210m used for forming the positive electrode mixture forming sheet 210s.

### 5.4.2 Step S32

The method proceeds to step S32 after step S31.

In the step of forming the negative electrode mixture 330 forming sheet in step S32, the negative electrode mixture forming sheet 330s which is the negative electrode mixture 330 forming sheet is formed.

The negative electrode mixture forming sheet 330s can be formed by, for example, the method as same the method described in the third embodiment.

The negative electrode mixture forming sheet 330s obtained in the present step is preferably obtained by removing the solvent from the slurry 330m used for forming the negative electrode mixture forming sheet 330s.

### 5.4.3 Step S33

The method proceeds to step S33 after step S32.

In the step of forming the solid electrolyte layer 20 forming sheet in step S33, the solid electrolyte layer forming sheet 20s which is the solid electrolyte layer 20 forming sheet is formed.

The solid electrolyte layer forming sheet 20s can be formed by, for example, the method same as the method described in the first embodiment.

The solid electrolyte layer forming sheet 20s obtained in the present step is preferably obtained by removing the solvent from the slurry 20m used for forming the solid electrolyte layer forming sheet 20s.

### 5.4.4 Step S34

The method proceeds to step S34 after step S33.

In the step of forming the molded object 450f in step S34, the positive electrode mixture forming sheet 210s, the solid electrolyte layer forming sheet 20s, and the negative electrode mixture forming sheet 330s are sequentially pressed in a stacked state and are bonded together. Thereafter, as shown in FIG. 20, a stacked sheet obtained by bonding is die-cut to obtain the molded object 450f.

### 5.4.5 Step S35

The method proceeds to step S35 after step S34.

In the step of calcining the molded object 450f in step S35, a heating step of heating the molded object 450f is performed, so that a portion formed of the positive electrode mixture forming sheet 210s is formed as the positive electrode mixture 210, a portion formed of the solid electrolyte layer forming sheet 20s is formed as the solid electrolyte layer 20, and a portion formed of the negative electrode mixture forming sheet 330s is formed as the negative electrode mixture 330. That is, a calcined body of the molded object 450f is a stacked body including the positive electrode mixture 210, the solid electrolyte layer 20, and the negative electrode mixture 330. This treatment corresponds to the heat treatment step in the method for producing a composite solid electrolyte molded body according to the present disclosure. Therefore, this treatment is preferably performed under the same conditions as those described in [3.2 Heat Treatment Step] described above. Accordingly, the same effects as those described above can be obtained.

### 5.4.6 Step S36

The method proceeds to step S36 after step S35.

In the step of forming the current collectors 41 and 42 in step S36, the current collector 41 is formed to be in contact with the surface 210a of the positive electrode mixture 210, and the current collector 42 is formed to be in contact with the surface 330b of the negative electrode mixture 330.

Although preferred embodiments according to the present disclosure have been described above, the present disclosure is not limited thereto.

For example, the solid electrolyte composite particle according to the present disclosure is not limited to one produced by the method described above.

When the present disclosure is applied to a lithium ion secondary battery, a configuration of the lithium ion secondary battery is not limited to configurations in the embodiments described above.

For example, when the present disclosure is applied to a lithium ion secondary battery, the lithium ion secondary battery is not limited to an all-solid battery, and may be, for example, a lithium ion secondary battery in which a porous separator is provided between a positive electrode mixture and a negative electrode and the separator is impregnated in an electrolytic solution.

The solid electrolyte composite particle according to the present disclosure may be applied to production of a separator. In such a case, excellent dendrite resistance is obtained.

When the present disclosure is applied to a lithium ion secondary battery, a method for producing the lithium ion secondary battery is not limited to the methods in the embodiments described above. For example, the order of steps in production of the lithium ion secondary battery may be different from those in the embodiments described above.

The method for producing the composite solid electrolyte molded body according to the present disclosure may have a step other than the molding step and the heat treatment step described above.

### EXAMPLES

Next, specific examples according to the present disclosure will be described.

### 6. Production of Solid Electrolyte Composite Particles Example 1

First, a first solution containing lanthanum nitrate hexahydrate as a lanthanum source, tetrabutoxy zirconium as a zirconium source, tri-n-butoxyantimony as an antimony source, pentaethoxy tantalum as a tantalum source, and 2-n-butoxyethanol as a solvent at a predetermined ratio was prepared, and a second solution containing lithium nitrate as a lithium compound and 2-n-butoxyethanol as a solvent at a predetermined ratio was prepared.

Next, the first solution and the second solution were mixed at a predetermined ratio, to obtain a mixed liquid in which a content ratio Li, La, Zr, Ta, and Sb was 6.3:3:1.3:0.5:0.2 in a molar ratio.

Next, 500 parts by mass of the mixed liquid described above was added into 100 parts by mass of Li₇La₃Zr₂O₁₂ particles having an average particle diameter of μm as the first solid electrolyte, and an ultrasonic cleaner with temperature control function US-1 manufactured by AS ONE Corporation was used to perform ultrasonic dispersion at 55° C. for 2 hours under conditions of an oscillation frequency of 38 kHz and an output of 80 W. The Li₇La₃Zr₂O₁₂ particles as the first solid electrolyte were produced as follows. That is, first, 2.59 parts by mass of a Li₂CO₃ powder as a lithium source, 4.89 parts by mass of a La₂O₃ powder as a lanthanum source, and 2.46 parts by mass of a ZrO₂ powder as a zirconium source were prepared, and the powders were crushed and mixed in an agate mortar to obtain a mixture. Next, 1 g of the mixture was filled in a pellet die provided with an exhaust port having an inner diameter of 13 mm, manufactured by Specac Inc., and was press-molded with a weight of 6 kN to obtain pellets as a molded object. The obtained pellets were placed into an alumina crucible and sintered at 1,250° C. for 8 hours in an air atmosphere to obtain solid electrolyte pellets formed of Li₇La₃Zr₂O₁₂. Thereafter, the solid electrolyte pellets were crushed by using an agate mortar to obtain Li₇La₃Zr₂O₁₂ particles having an average particle diameter of 7 μm.

Thereafter, a supernatant was removed by performing centrifugation at 10,000 rpm for 3 minutes by using a centrifuge, the obtained precipitates were charged into a petri dish, and liquid components were evaporated by performing a drying treatment at 180° C. for 60 minutes in an Ar atmosphere. Thereafter, a solid content of the mixed liquid adhering to a surface of the first solid electrolyte was temporarily calcined by performing a heat treatment at 540° C. for 60 minutes in an Ar atmosphere, and a coating film containing an oxide was formed.

Thereafter, a powder obtained by the temporarily calcination was mixed with the mixed liquid in the same manner as described above, and treatments including ultrasonic dispersion, centrifugation, drying, and temporarily calcination were performed for a predetermined number of times, thereby obtaining a powder, as an aggregate of solid electrolyte composite particles, each containing a mother particle formed of Li₇La₃Zr₂O₁₂ particles as the first solid electrolyte and a coating layer provided on a surface of the mother particle. The coating layer was formed of a material containing a precursor oxide formed of a pyrochlore type crystal phase as an oxide different from the first solid electrolyte, LiCO₃, and LiNO₃.

### Examples 2 to 11

Solid electrolyte composite particles were produced in a similar manner to those in example 1 except that the type and the using amount of the raw material used in preparation of the mixed liquid were adjusted, the composition of the mixed liquid was shown in Tables 1 to 3, the first solid electrolyte was shown in Tables 1 to 3, and the number of times of repeating a series of treatment including mixing the first solid electrolyte with the mixed liquid, ultrasonic dispersion, centrifugation, drying and temporarily calcination was adjusted.

### Comparative Examples 1 to 4

The coating layers were not formed on the particles of the first solid electrolyte used in Examples 1 to 4, and the particles were used as they were. In other words, instead of the solid electrolyte composite particles, solid electrolyte particles without being coated with the coating layers were prepared in Comparative Examples 1 to 4.

### Comparative Examples 5 to 8

Solid electrolyte composite particles were produced in a similar manner to those in Examples 1 to 4 except that the type and the using amount of the raw material used in preparation of the mixed liquid were adjusted, and the composition of the mixed liquid did not contain an oxo acid compound as shown in Tables 3 and 4.

### Comparative Example 9

First, a mixed liquid was prepared in the same manner as in Example 1.

Next, a first heat treatment was performed at 180° C. for 60 minutes in an Ar atmosphere under a state in which the mixed liquid was charged into a titanium beaker, to obtain a gel-like mixture.

Next, the gel-like mixture obtained as described above was subjected to a second heat treatment at 540° C. for 60 minutes in an Ar atmosphere to obtain a solid composition as an ash-like thermal decomposition product.

The solid composition obtained as described above was a composition containing a precursor oxide formed of a pyrochlore type crystal phase and a lithium compound. After the ash-like thermal decomposition product was crushed in an agate mortar, 1 g of the mixture was filled in a pellet die provided with an exhaust port having an inner diameter of 13 mm, manufactured by Specac Inc., and was press-molded with a weight of 6 kN to obtain pellets as a molded object. The obtained pellets were placed in an alumina crucible and sintered at 900° C. for 8 hours in an air atmosphere to obtain solid electrolyte pellets formed of Li_{6.3}La₃Zr_{1.3}Sb_{0.5}Ta_{0.2}O₁₂. A ratio of a content of the oxo acid compound to a content of the precursor oxide in the obtained solid composition, that is, a value of XO/XP where XP (mass %) is a content of the precursor oxide in the solid composition and XO (mass %) is a content of the oxo acid compound in the solid composition, was 0.024.

In this Comparative Example, a solid composition as an ash-like thermal decomposition product was used. In other words, instead of the solid electrolyte composite particles, particles formed of a material the same as a constituent material of the coating layer in Example 1 were used in this Comparative Example.

### Comparative Examples 10 and 11

A solid composition as an ash-like thermal decomposition product was produced in a similar manner to Comparative Example 9 except that components same as those used in Examples 2 and 3 were used as a mixed liquid.

A sample of the solid electrolyte composite particle according to each of Examples was processed into a thin flake by a FIB cross section processing device Helios 600 manufactured by FEI Inc., and an element distribution and a composition were examined by various analysis methods. Based on observation with a transmission electron microscope using JEM-ARM 200F manufactured by JEOL Ltd. and a result of selected area electron diffraction, it was confirmed that the coating layer of the solid electrolyte composite particle included a relatively large amorphous region of about several hundred nm or more and an aggregate region formed of nanocrystals of 30 nm or less. According to an energy dispersive X-ray spectroscopy and an energy loss spectroscopy using JED-2300T manufactured by JEOL Ltd., lithium, carbon, and oxygen were detected from the amorphous region of the coating layer of the solid electrolyte composite particle according to each of Examples, and lanthanum, zirconium, and the element M were detected from the aggregate region formed of nanocrystals.

A composition of the mixed liquid used in production of the solid electrolyte composite particle of each of Examples and Comparative Examples 5 to 8 and conditions for producing the solid electrolyte composite particles are collectively shown in Tables 1, 2, 3, and 4, and conditions of the solid electrolyte composite particles in each of Examples and each Comparative Examples are collectively shown in Tables 5 and 6. In Comparative Examples 1 to 4 and 9 to 11, conditions for producing finally obtained particles and conditions of the particles were shown in these tables instead of the solid electrolyte composite particles. In Comparative Examples 9 to 11, the composition of the particles was shown in a column of the constituent material of the coating layer, and the average particle diameter of the particles was shown in a column of the thickness of the coating layer in Table 6. Tables 5 and 6 showed a value of XO/XP, a value of XL/XP, and a value of XO/XL where the content of the oxo acid compound in the coating layer was XO (mass %), the content of the precursor oxide in the coating layer was XP (mass %), and the content of the lithium compound in the coating layer was XL (mass %). When an image of backscattered electrons was obtained by measuring the solid electrolyte composite particles in each of Examples and Comparative Examples 5 to 8 using a scanning electron microscope (XL30 manufactured by FEI Inc.), it was confirmed that the coating layer was formed on the surface of the mother particle formed of the first solid electrolyte containing lithium. When the coating layer constituting the solid electrolyte composite particles in each of Examples was measured by TG-DTA at a temperature rising rate of 10° C./min, only exothermic peak in a range of 300° C. or higher and 1000° C. or lower was observed. Therefore, it can be said that the coating layer constituting the solid electrolyte composite particle in each of Examples is substantially formed of a single crystal phase. For the solid electrolyte composite particle in each of Examples, a content of components other than the first solid electrolyte in the mother particle was 0.1 mass % or less, and a content of components other than the oxide different from the first solid electrolyte, the lithium compound, and the oxo acid compound in the coating layer was 1 mass % or less. The solid electrolyte composite particle was formed of the mother particle and the coating layer, and contained no constitution other than the mother particle and the coating layer. For the powder as an aggregate of the solid electrolyte composite particles in each of Examples, a content of a constituent other than the solid electrolyte composite particles in the powder, that is, a content of a constituent other than constituent particles containing the mother particle and the coating layer, was 5 mass % or less. For the solid electrolyte composite particle in each of Examples, a coating ratio of the coating layer to the outer surface of the mother particle was 10% or more. The precursor oxide constituting the coating layer of the solid electrolyte composite particle in each of Examples had a pyrochlore type crystal. A crystal particle diameter of the precursor oxide contained in the coating layer of the solid electrolyte composite particle in each of Examples was 20 nm or more and 160 nm or less.

TABLE 1

| | Composition of mixed liquid | | | | | | |
|---|---|---|---|---|---|---|---|
| | Raw material compound | | Solvent | | First solid electrolyte | | |
| | | Content | | Content | | | Particle |
| | | (part by | | (part by | | Crystal | diameter |
| | Type | mass) | Type | mass) | Composition | phase | [μm] |
| Example 1 | Tetrabutoxy zirconium | 5.0 | 2-n-butoxy- | 304 | Li₇La₃Zr₂O₁₂ | Garnet type | 7 |
| | Tri-butoxyantimony | 1.71 | ethanol | | | | |
| | Pentaethoxy tantalum | 0.81 | | | | | |
| | Lithium nitrate | 4.34 | | | | | |
| | Lanthanum nitrate hexahydrate | 12.99 | | | | | |
| Example 2 | Tetrabutoxy zirconium | 6.71 | 2-n-butoxy- | 304 | Li₁₊ₓAlₓTi₂₋ₓ(PO₄)₃ | NASICON | 7 |
| | Pentaethoxy tantalum | 1.02 | ethanol | | | type | |
| | Lithium nitrate | 4.65 | | | | | |
| | Lanthanum nitrate hexahydrate | 12.99 | | | | | |
| Example 3 | Tetrabutoxy zirconium | 6.70 | 2-n-butoxy- | 304 | La_{0.57}Li_{0.29}TiO₃ | Perovskite | 7 |
| | Pentaethoxy niobium | 0.80 | ethanol | | | type | |
| | Lithium nitrate | 4.65 | | | | | |
| | Lanthanum nitrate hexahydrate | 12.99 | | | | | |
| Example 4 | Tetrabutoxy zirconium | 5.0 | 2-n-butoxy- | 304 | Li_{6.3}La₃Zr_{1.3}Sb_{0.5}Ta_{0.2}O₁₂ | Garnet type | 7 |
| | Tri-butoxyantimony | 1.71 | ethanol | | | | |
| | Pentaethoxy tantalum | 0.81 | | | | | |
| | Lithium nitrate | 4.34 | | | | | |
| | Lanthanum nitrate hexahydrate | 12.99 | | | | | |
| Example 5 | Tetrabutoxy zirconium | 5.0 | 2-n-butoxy- | 304 | Li_{6.3}La₃Zr_{1.3}Sb_{0.5}Ta_{0.2}O₁₂ | Garnet type | 7 |
| | Tri-butoxyantimony | 1.71 | ethanol | | | | |
| | Pentaethoxy tantalum | 0.81 | | | | | |
| | Lithium sulfate | 7.42 | | | | | |
| | Lanthanum nitrate hexahydrate | 12.99 | | | | | |

TABLE 2

| | Composition of mixed liquid | | | | | | |
|---|---|---|---|---|---|---|---|
| | Raw material compound | | Solvent | | First solid electrolyte | | |
| | | Content | | Content | | | Particle |
| | | (part by | | (part by | | Crystal | diameter |
| | Type | mass) | Type | mass) | Composition | phase | [μm] |
| Example 6 | Tetrabutoxy zirconium | 5.0 | 2-n-butoxy- | 304 | Li_{6.3}La₃Zr_{1.3}Sb_{0.5}Ta_{0.2}O₁₂ | Garnet type | 7 |
| | Tri-butoxyantimony | 1.71 | ethanol | | | | |
| | Pentaethoxy tantalum | 0.81 | | | | | |
| | Lithium nitrate | 4.34 | | | | | |
| | Lanthanum nitrate hexahydrate | 12.99 | | | | | |
| Example 7 | Tetrabutoxy zirconium | 5.0 | 2-n-butoxy- | 304 | Li_{6.3}La₃Zr_{1.3}Sb_{0.5}Ta_{0.2}O₁₂ | Garnet type | 7 |
| | Tri-butoxyantimony | 1.71 | ethanol | | | | |
| | Pentaethoxy tantalum | 0.81 | | | | | |
| | Lithium nitrate | 4.34 | | | | | |
| | Lanthanum nitrate hexahydrate | 12.99 | | | | | |
| Example 8 | Tetrabutoxy zirconium | 5.0 | 2-n-butoxy- | 304 | Li_{6.3}La₃Zr_{1.3}Sb_{0.5}Ta_{0.2}O₁₂ | Garnet type | 7 |
| | Tri-butoxyantimony | 1.71 | ethanol | | | | |
| | Pentaethoxy tantalum | 0.81 | | | | | |
| | Lithium nitrate | 4.34 | | | | | |
| | Lanthanum nitrate hexahydrate | 12.99 | | | | | |
| Example 9 | Tetrabutoxy zirconium | 5.0 | 2-n-butoxy- | 304 | Li_{6.3}La₃Zr_{1.3}Sb_{0.5}Ta_{0.2}O₁₂ | Garnet type | 14 |
| | Tri-butoxyantimony | 1.71 | ethanol | | | | |
| | Pentaethoxy tantalum | 0.81 | | | | | |
| | Lithium nitrate | 4.34 | | | | | |
| | Lanthanum nitrate hexahydrate | 12.99 | | | | | |

TABLE 3

| | Composition of mixed liquid | | | | | | |
|---|---|---|---|---|---|---|---|
| | Raw material compound | | Solvent | | First solid electrolyte | | |
| | | Content | | Content | | | Particle |
| | | (part by | | (part by | | Crystal | diameter |
| | Type | mass) | Type | mass) | Composition | phase | [μm] |
| Example 10 | Tetrabutoxy zirconium | 5.0 | 2-n-butoxy- | 304 | Li_{6.3}La₃Zr_{1.3}Sb_{0.5}Ta_{0.2}O₁₂ | Garnet type | 5 |
| | Tri-butoxyantimony | 1.71 | ethanol | | | | |
| | Pentaethoxy tantalum | 0.81 | | | | | |
| | Lithium nitrate | 4.34 | | | | | |
| | Lanthanum nitrate hexahydrate | 12.99 | | | | | |
| Example 11 | Tetrabutoxy zirconium | 5.0 | 2-n-butoxy- | 304 | Li_{6.3}La₃Zr_{1.3}Sb_{0.5}Ta_{0.2}O₁₂ | Garnet type | 3 |
| | Tri-butoxyantimony | 1.71 | ethanol | | | | |
| | Pentaethoxy tantalum | 0.81 | | | | | |
| | Lithium nitrate | 4.34 | | | | | |
| | Lanthanum nitrate hexahydrate | 12.99 | | | | | |
| Comparative | — | — | — | — | Li₇La₃Zr₂O₁₂ | Garnet type | 7 |
| Example 1 | | | | | | | |
| Comparative | — | — | — | — | Li₁₊ₓAlₓTi₂₋ₓ(PO₄)₃ | NASICON | 7 |
| Example 2 | | | | | | type | |
| Comparative | — | — | — | — | La_{0.57}Li_{0.29}TiO₃ | Perovskite | 7 |
| Example 3 | | | | | | type | |
| Comparative | — | — | — | — | Li_{6.3}La₃Zr_{1.3}Sb_{0.5}Ta_{0.2}O₁₂ | Garnet type | 7 |
| Example 4 | | | | | | | |
| Comparative | Tetrabutoxy zirconium | 5 | 2-n-butoxy- | 304 | Li₇La₃Zr₂O₁₂ | Garnet type | 7 |
| Example 5 | Tri-butoxyantimony | 1.71 | ethanol | | | | |
| | Pentaethoxy tantalum | 0.81 | | | | | |
| | Lithium 2-ethylhexanoate | 9.45 | | | | | |
| | Lanthanum 2-ethylhexanoate | 17 | | | | | |
| Comparative | Tetrabutoxy zirconium | 6.71 | 2-n-butoxy- | 304 | Li₁₊ₓAlₓTi₂₋ₓ(PO₄)₃ | NASICON | 7 |
| Example 6 | Pentaethoxy tantalum | 1.02 | ethanol | | | type | |
| | Lithium 2-ethylhexanoate | 10.2 | | | | | |
| | Lanthanum 2-ethylhexanoate | 17 | | | | | |

TABLE 4

| | Composition of mixed liquid | | | | | | |
|---|---|---|---|---|---|---|---|
| | Raw material compound | | Solvent | | First solid electrolyte | | |
| | | Content | | Content | | | Particle |
| | | (part by | | (part by | | Crystal | diameter |
| | Type | mass) | Type | mass) | Composition | phase | [μm] |
| Comparative | Tetrabutoxy zirconium | 6.7 | 2-n-butoxy- | 304 | La_{0.57}Li_{0.29}TiO₃ | Perovskite | 7 |
| Example 7 | Pentaethoxy niobium | 0.8 | ethanol | | | type | |
| | Lithium 2-ethylhexanoate | 10.2 | | | | | |
| | Lanthanum 2-ethylhexanoate | 17 | | | | | |
| Comparative | Tetrabutoxy zirconium | 5 | 2-n-butoxy- | 304 | Li_{6.3}La₃Zr_{1.3}Sb_{0.5}Ta_{0.2}O₁₂ | Garnet type | 7 |
| Example 8 | Tri-butoxyantimony | 1.71 | ethanol | | | | |
| | Pentaethoxy tantalum | 0.81 | | | | | |
| | Lithium 2-ethylhexanoate | 9.45 | | | | | |
| | Lanthanum 2-ethylhexanoate | 17 | | | | | |
| Comparative | Tetrabutoxy zirconium | 5 | 2-n-butoxy- | 304 | — | — | — |
| Example 9 | Tri-butoxyantimony | 1.71 | ethanol | | | | |
| | Pentaethoxy tantalum | 0.81 | | | | | |
| | Lithium nitrate | 4.34 | | | | | |
| | Lanthanum nitrate hexahydrate | 12.99 | | | | | |
| Comparative | Tetrabutoxy zirconium | 6.71 | 2-n-butoxy- | 304 | — | — | — |
| Example 10 | Pentaethoxy tantalum | 1.02 | ethanol | | | | |
| | Lithium nitrate | 4.65 | | | | | |
| | Lanthanum nitrate hexahydrate | 12.99 | | | | | |
| Comparative | Tetrabutoxy zirconium | 6.70 | 2-n-butoxy- | 304 | — | — | — |
| Example 11 | Pentaethoxy niobium | 0.80 | ethanol | | | | |
| | Lithium nitrate | 4.65 | | | | | |
| | Lanthanum nitrate hexahydrate | 12.99 | | | | | |

TABLE 5

| | | | | Coating layer | | |
|---|---|---|---|---|---|---|
| | | | | Precursor oxide | | |
| | Mother particle | | | | Crystal | |
| | | | Particle | | particle | Content |
| | Compo- | Crystal | diameter | Crystal | diameter | XP |
| | sition | phase | [μm] | phase | [nm] | (mass %) |
| Example 1 | Li₇La₃Zr₂O₁₂ | Garnet type | 7 | Pyrochlore | 20 | 83 |
| | | | | type | | |
| Example 2 | Li₁₊ₓAlₓTi₂₋ₓ(PO₄)₃ | NASICON | 7 | Pyrochlore | 20 | 81 |
| | | type | | type | | |
| Example 3 | La_{0.57}Li_{0.29}TiO₃ | Perovskite | 7 | Pyrochlore | 20 | 81 |
| | | type | | type | | |
| Example 4 | Li_{6.3}La₃Zr_{1.3}Sb_{0.5}Ta_{0.2}O₁₂ | Garnet type | 7 | Pyrochlore | 20 | 83 |
| | | | | type | | |
| Example 5 | Li_{6.3}La₃Zr_{1.3}Sb_{0.5}Ta_{0.2}O₁₂ | Garnet type | 7 | Pyrochlore | 20 | 83 |
| | | | | type | | |
| Example 6 | Li_{6.3}La₃Zr_{1.3}Sb_{0.5}Ta_{0.2}O₁₂ | Garnet type | 7 | Pyrochlore | 20 | 83 |
| | | | | type | | |
| Example 7 | Li_{6.3}La₃Zr_{1.3}Sb_{0.5}Ta_{0.2}O₁₂ | Garnet type | 7 | Pyrochlore | 20 | 83 |
| | | | | type | | |
| Example 8 | Li_{6.3}La₃Zr_{1.3}Sb_{0.5}Ta_{0.2}O₁₂ | Garnet type | 7 | Pyrochlore | 20 | 83 |
| | | | | type | | |
| Example 9 | Li_{6.3}La₃Zr_{1.3}Sb_{0.5}Ta_{0.2}O₁₂ | Garnet type | 14 | Pyrochlore | 20 | 83 |
| | | | | type | | |
| Example 10 | Li_{6.3}La₃Zr_{1.3}Sb_{0.5}Ta_{0.2}O₁₂ | Garnet type | 5 | Pyrochlore | 20 | 83 |
| | | | | type | | |
| Example 11 | Li_{6.3}La₃Zr_{1.3}Sb_{0.5}Ta_{0.2}O₁₂ | Garnet type | 3 | Pyrochlore | 20 | 83 |
| | | | | type | | |

| | Coating layer | | | | | | | |
|---|---|---|---|---|---|---|---|---|
| | Lithium compound | | Oxo acid compound | | | | | |
| | | Content | | Content | | | | |
| | Compo- | XL | Compo- | XO | Thickness | | | |
| | sition | (mass %) | sition | (mass %) | [μm] | XO/XP | XL/XP | XO/XL |
| Example 1 | Li₂CO₃ | 15 | LiNO₃ | 2 | 0.5 | 0.024 | 0.18 | 0.13 |
| | LiNO₃ | | | | | | | |
| Example 2 | Li₂CO₃ | 17 | LiNO₃ | 2 | 0.5 | 0.025 | 0.21 | 0.12 |
| | LiNO₃ | | | | | | | |
| Example 3 | Li₂CO₃ | 17 | LiNO₃ | 2 | 0.5 | 0.025 | 0.21 | 0.12 |
| | LiNO₃ | | | | | | | |
| Example 4 | Li₂CO₃ | 15 | LiNO₃ | 2 | 0.5 | 0.024 | 0.18 | 0.13 |
| | LiNO₃ | | | | | | | |
| Example 5 | Li₂CO₃ | 15 | Li₂SO₄ | 2 | 0.5 | 0.024 | 0.18 | 0.13 |
| | LiSO₄ | | | | | | | |
| Example 6 | Li₂CO₃ | 15 | LiNO₃ | 2 | 1.0 | 0.024 | 0.18 | 0.13 |
| | LiNO₃ | | | | | | | |
| Example 7 | Li₂CO₃ | 15 | LiNO₃ | 2 | 0.1 | 0.024 | 0.18 | 0.13 |
| | LiNO₃ | | | | | | | |
| Example 8 | Li₂CO₃ | 15 | LiNO₃ | 2 | 0.03 | 0.024 | 0.18 | 0.13 |
| | LiNO₃ | | | | | | | |
| Example 9 | Li₂CO₃ | 15 | LiNO₃ | 2 | 0.5 | 0.024 | 0.18 | 0.13 |
| | LiNO₃ | | | | | | | |
| Example 10 | Li₂CO₃ | 15 | LiNO₃ | 2 | 0.5 | 0.025 | 0.21 | 0.12 |
| | LiNO₃ | | | | | | | |
| Example 11 | Li₂CO₃ | 15 | LiNO₃ | 2 | 0.5 | 0.025 | 0.21 | 0.12 |
| | LiNO₃ | | | | | | | |

TABLE 6

| | | | | Coating layer | | |
|---|---|---|---|---|---|---|
| | | | | Precursor oxide | | |
| | Mother particle | | | | Crystal | |
| | | | Particle | | particle | Content |
| | Compo- | Crystal | diameter | Crystal | diameter | XP |
| | sition | phase | [μm] | phase | [nm] | (mass %) |
| Comparative | Li₇La₃Zr₂O₁₂ | Garnet type | 7 | — | — | — |
| Example 1 | | | | | | |
| Comparative | Li₁₊ₓAlₓTi₂₋ₓ(PO₄)₃ | NASICON | 7 | — | — | — |
| Example 2 | | type | | | | |
| Comparative | La_{0.57}Li_{0.29}TiO₃ | Perovskite | 7 | — | — | — |
| Example 3 | | type | | | | |
| Comparative | Li_{6.3}La₃Zr_{1.3}Sb_{0.5}Ta_{0.2}O₁₂ | Garnet type | 7 | — | — | — |
| Example 4 | | | | | | |
| Comparative | Li₇La₃Zr₂O₁₂ | Garnet type | 7 | Pyrochlore | 20 | 83 |
| Example 5 | | | | type | | |
| Comparative | Li₁₊ₓAlₓTi₂₋ₓ(PO₄)₃ | NASICON | 7 | Pyrochlore | 20 | 83 |
| Example 6 | | type | | type | | |
| Comparative | La_{0.57}Li_{0.29}TiO₃ | Perovskite | 7 | Pyrochlore | 20 | 83 |
| Example 7 | | type | | type | | |
| Comparative | Li_{6.3}La₃Zr_{1.3}Sb_{0.5}Ta_{0.2}O₁₂ | Garnet type | 7 | Pyrochlore | 20 | 83 |
| Example 8 | | | | type | | |
| Comparative | — | — | — | Pyrochlore | 20 | 83 |
| Example 9 | | | | type | | |
| Comparative | — | — | — | Pyrochlore | 20 | 81 |
| Example 10 | | | | type | | |
| Comparative | — | — | — | Pyrochlore | 20 | 81 |
| Example 11 | | | | type | | |

| | Coating layer | | | | | | | |
|---|---|---|---|---|---|---|---|---|
| | Lithium compound | | Oxo acid compound | | | | | |
| | | Content | | Content | | | | |
| | Compo- | XL | Compo- | XO | Thickness | | | |
| | sition | (mass %) | sition | (mass %) | [μm] | XO/XP | XL/XP | XO/XL |
| Comparative | — | — | — | — | — | — | — | — |
| Example 1 | | | | | | | | |
| Comparative | — | — | — | — | — | — | — | — |
| Example 2 | | | | | | | | |
| Comparative | — | — | — | — | — | — | — | — |
| Example 3 | | | | | | | | |
| Comparative | — | — | — | — | — | — | — | — |
| Example 4 | | | | | | | | |
| Comparative | Li₂CO₃ | 17 | — | — | 0.5 | 0 | 0.2 | 0 |
| Example 5 | | | | | | | | |
| Comparative | Li₂CO₃ | 17 | — | — | 0.5 | 0 | 0.2 | 0 |
| Example 6 | | | | | | | | |
| Comparative | Li₂CO₃ | 17 | — | — | 0.5 | 0 | 0.2 | 0 |
| Example 7 | | | | | | | | |
| Comparative | Li₂CO₃ | 17 | — | — | 0.5 | 0 | 0.2 | 0 |
| Example 8 | | | | | | | | |
| Comparative | Li₂CO₃ | 15 | LiNO₃ | 2 | — | 0.024 | 0.18 | 0.13 |
| Example 9 | LiNO₃ | | | | | | | |
| Comparative | Li₂CO₃ | 17 | LiNO₃ | 2 | — | 0.024 | 0.18 | 0.13 |
| Example 10 | LiNO₃ | | | | | | | |
| Comparative | Li₂CO₃ | 17 | LiNO₃ | 2 | — | 0.024 | 0.18 | 0.13 |
| Example 11 | LiNO₃ | | | | | | | |

### 7. Evaluation

The following evaluations were performed for Examples and Comparative Examples described above.

### 7.1 Calcination Denseness Evaluation

From each of the powders as an aggregate of particles finally obtained in Examples and Comparative Examples described above, 1 g of a sample was taken out.

Next, the sample was filled in a pellet die provided with an exhaust port having an inner diameter of 13 mm, manufactured by Specac Inc., and was press-molded with a weight of 6 kN to obtain pellets as a molded object. The obtained pellets were placed into an alumina crucible and sintered at 900° C. for 8 hours in an air atmosphere to obtain a calcined body.

For the obtained calcined body, a porosity of the calcined body was determined based on shape measurement and weight measurement. The smaller the porosity, the better the denseness. For all calcined bodies in Examples and Comparative Examples, a content of a liquid component was 0.1 mass % or less, and a content of the oxo acid compound was 10 ppm or less. The second solid electrolyte formed of the constituent material of the coating layer had a cubic garnet type crystal phase in each of Examples.

### 7.2 Ionic Conductivity Evaluation

Two sides of the calcined body in a pellet form obtained in 7.1 according to each of Examples and Comparative Examples were attached with a lithium metal foil (manufactured by Honjo Chemical Corporation) having a diameter of 8 mm to form activation electrodes, and an alternating current impedance was measured using an alternating current impedance analyzer Solatron 1260 (manufactured by Solatron Analytical) to obtain a lithium ionic conductivity. The measurement was performed at an alternating current amplitude of 10 mV in a frequency range of 10⁷ Hz to 10⁻¹ Hz. The lithium ionic conductivity obtained by the measurement shows a total lithium ionic conductivity including a bulk lithium ionic conductivity of the calcined body and a lithium ionic conductivity at a grain boundary. The larger the value of the lithium ionic conductivity, the better the ionic conductivity.

The results are collectively shown in Table 7.

TABLE 7

| | Solid electrolyte derived from coating | | Mother particle | | Denseness | |
|---|---|---|---|---|---|---|
| | | Thickness | | Particle | Porosity after | Ionic |
| | Composition after | of coating | | diameter | calcination | conductivity |
| | calcination | (μm) | Composition | (μm) | [vol %] | [mS/cm] |
| Example 1 | Li_{6.3}La₃Zr_{1.3}Sb_{0.5}Ta_{0.2}O₁₂ | 0.5 | Li₇La₃Zr₂O₁₂ | 7 | 7 | 0.1 |
| Example 2 | Li_{6.75}La₃Zr_{1.75}Ta_{0.25}O₁₂ | 0.5 | Li₁₊ₓAlₓTi₂₋ₓ(PO₄)₃ | 7 | 10 | 0.1 |
| Example 3 | Li_{6.75}La₃Zr_{1.75}Nb_{0.25}O₁₂ | 0.5 | La_{0.57}Li_{0.29}TiO₃ | 7 | 10 | 0.2 |
| Example 4 | Li_{6.3}La₃Zr_{1.3}Sb_{0.5}Ta_{0.2}O₁₂ | 0.5 | Li_{6.3}La₃Zr_{1.3}Sb_{0.5}Ta_{0.2}O₁₂ | 7 | 5 | 1.2 |
| Example 5 | Li_{6.3}La₃Zr_{1.3}Sb_{0.5}Ta_{0.2}O₁₂ | 0.5 | Li_{6.3}La₃Zr_{1.3}Sb_{0.5}Ta_{0.2}O₁₂ | 7 | 5 | 0.8 |
| Example 6 | Li_{6.3}La₃Zr_{1.3}Sb_{0.5}Ta_{0.2}O₁₂ | 1 | Li_{6.3}La₃Zr_{1.3}Sb_{0.5}Ta_{0.2}O₁₂ | 7 | 20 | 0.5 |
| Example 7 | Li_{6.3}La₃Zr_{1.3}Sb_{0.5}Ta_{0.2}O₁₂ | 0.1 | Li_{6.3}La₃Zr_{1.3}Sb_{0.5}Ta_{0.2}O₁₂ | 7 | 20 | 0.5 |
| Example 8 | Li_{6.3}La₃Zr_{1.3}Sb_{0.5}Ta_{0.2}O₁₂ | 0.03 | Li_{6.3}La₃Zr_{1.3}Sb_{0.5}Ta_{0.2}O₁₂ | 7 | 30 | 0.3 |
| Example 9 | Li_{6.3}La₃Zr_{1.3}Sb_{0.5}Ta_{0.2}O₁₂ | 0.5 | Li_{6.3}La₃Zr_{1.3}Sb_{0.5}Ta_{0.2}O₁₂ | 14 | 20 | 0.6 |
| Example 10 | Li_{6.3}La₃Zr_{1.3}Sb_{0.5}Ta_{0.2}O₁₂ | 0.5 | Li_{6.3}La₃Zr_{1.3}Sb_{0.5}Ta_{0.2}O₁₂ | 5 | 10 | 0.8 |
| Example 11 | Li_{6.3}La₃Zr_{1.3}Sb_{0.5}Ta_{0.2}O₁₂ | 0.5 | Li_{6.3}La₃Zr_{1.3}Sb_{0.5}Ta_{0.2}O₁₂ | 3 | 20 | 0.5 |
| Comparative | — | — | Li₇La₃Zr₂O₁₂ | 7 | 40 | 0.02 |
| Example 1 | | | | | | |
| Comparative | — | — | Li₁₊ₓAlₓTi₂₋ₓ(PO₄)₃ | 7 | 40 | 0.01 |
| Example 2 | | | | | | |
| Comparative | — | — | La_{0.57}Li_{0.29}TiO₃ | 7 | 35 | 0.01 |
| Example 3 | | | | | | |
| Comparative | — | — | Li_{6.3}La₃Zr_{1.3}Sb_{0.5}Ta_{0.2}O₁₂ | 7 | 30 | 0.03 |
| Example 4 | | | | | | |
| Comparative | Li_{6.3}La₃Zr_{1.3}Sb_{0.5}Ta_{0.2}O₁₂ | 0.5 | Li₇La₃Zr₂O₁₂ | 7 | 30 | 0.01 |
| Example 5 | | | | | | |
| Comparative | Li_{6.3}La₃Zr_{1.3}Sb_{0.5}Ta_{0.2}O₁₂ | 0.5 | Li₁₊ₓAlₓTi₂₋ₓ(PO₄)₃ | 7 | 35 | 0.02 |
| Example 6 | | | | | | |
| Comparative | Li_{6.3}La₃Zr_{1.3}Sb_{0.5}Ta_{0.2}O₁₂ | 0.5 | La_{0.57}Li_{0.29}TiO₃ | 7 | 35 | 0.03 |
| Example 7 | | | | | | |
| Comparative | Li_{6.3}La₃Zr_{1.3}Sb_{0.5}Ta_{0.2}O₁₂ | 0.5 | Li_{6.3}La₃Zr_{1.3}Sb_{0.5}Ta_{0.2}O₁₂ | 7 | 25 | 0.04 |
| Example 8 | | | | | | |
| Comparative | Li_{6.3}La₃Zr_{1.3}Sb_{0.5}Ta_{0.2}O₁₂ | — | — | — | 45 | 0.05 |
| Example 9 | | | | | | |
| Comparative | Li_{6.75}La₃Zr_{1.75}Ta_{0.25}O₁₂ | — | — | — | 45 | 0.01 |
| Example 10 | | | | | | |
| Comparative | Li_{6.75}La₃Zr_{1.75}Nb_{0.25}O₁₂ | — | — | — | 45 | 0.02 |
| Example 11 | | | | | | |

As is clear from Table 7, excellent results were obtained in the present disclosure. In contrast, satisfactory results were not obtained in Comparative Examples.

What is claimed is:

1. A solid electrolyte composite particle comprising:
a mother particle formed of a first solid electrolyte containing at least lithium; and
a coating layer formed of a material containing an oxide different from the first solid electrolyte, a lithium compound, and an oxo acid compound, and coating at least a part of a surface of the mother particle.

2. The solid electrolyte composite particle according to claim 1, wherein
the first solid electrolyte is an oxide solid electrolyte.

3. The solid electrolyte composite particle according to claim 1, wherein
the first solid electrolyte is a garnet type oxide solid electrolyte.

4. The solid electrolyte composite particle according to claim 1, wherein
the oxo acid compound contains at least one of a nitrate ion and a sulfate ion as an oxo anion.

5. The solid electrolyte composite particle according to claim 1, wherein
a crystal phase of the oxide is a pyrochlore type crystal.

6. The solid electrolyte composite particle according to claim 1, wherein
an average particle diameter of the mother particles is 1.0 μm or more and 30 μm or less.

7. The solid electrolyte composite particle according to claim 1, wherein
an average thickness of the coating layers is 0.002 μm or more and 3.0 μm or less.

8. The solid electrolyte composite particle according to claim 1, wherein
the coating layer coats 10% or more of an area of the surface of the mother particle.

9. A powder comprising:
a plurality of the solid electrolyte composite particles according to claim 1.

10. A method for producing a composite solid electrolyte molded body, comprising:
a molding step of obtaining a molded body by molding a composition containing a plurality of the solid electrolyte composite particles according to claim 1; and
a heat treatment step of converting a constituent material of the coating layer into a second solid electrolyte that is an oxide by subjecting the molded body to a heat treatment, and forming the composite solid electrolyte molded body containing the first solid electrolyte and the second solid electrolyte.

11. The method for producing a composite solid electrolyte molded body according to claim 10, wherein
a heating temperature for the molded body in the heat treatment step is 700° C. or higher and 1,000° C. or lower.

12. The method for producing a composite solid electrolyte molded body according to claim 10, wherein
the first solid electrolyte and the second solid electrolyte are substantially the same.
